(19) United States
(12) Patent Application Publication
(10) Pub. No.: US 2015/0213397 A1
(43) Pub. Date: Jul. 30, 2015

(54) CONSTRUCTION COMPUTER SOFTWARE RELATED METHOD AND APPARATUS

(71) Applicant: Andrew Arena, White Plains, NY (US)

(72) Inventor: Andrew Arena, White Plains, NY (US)

(21) Appl. No.: 14/167,357

(22) Filed: Jan. 29, 2014

(51) Int. Cl. G06Q 10/06

(52) U.S. Cl. CPC G06Q 10/063118

(57) ABSTRACT

A computer processor and a computer memory, such that the computer processor may be programmed to store in the computer memory, a name of a main contractor for a construction project. one or more names for subcontractors for the construction project, a main project folder for the construction project, a main contractor folder for the construction project, and one or more subcontractor folders for the construction project. The main contractor folder may include data relating to one or more responsibilities of the main contractor for the construction project. Each of the one or more subcontractor folders may include data relating to one or more responsibilities of a subcontractor to whom each of the one or more subcontractor folders belongs. The main project folder may include data which is also included in the main contractor folder and data which is also included in each of the one or more subcontractor folders.

### FIELD OF THE INVENTION

This invention relates to improved methods and apparatus concerning construction computer software.

### BACKGROUND OF THE INVENTION

Known construction related computer software spans greatly between clientele demand and computer software function. Computer software companies aim to attract a broad clientele varying from small to large-scale projects ranging from home developers, general contractors, construction managers, single prime contractors, subcontractor's, city and town municipal construction management departments, architectural designers, engineer designers, private developers and consulting project managers. Construction related computer software has been developed to attract construction professionals to focus on several disciplines ranging from: (1) cost accounting, (2) estimating and scheduling, (3) project management and estimating, (4) project management and scheduling, (5) project management, (6) cost accounting and estimating, and (7) project management and cost accounting.

However, contractors are struggling to find document control software to realistically serve their needs in a project management capacity. As market research shows, existing known construction computer software attempts to reach a very broad clientele designed with complex functions that require lengthy training, costly price points, expensive monthly fees, limited user agreements, program design lacking intuition and a one size fits all philosophy. Traditional formats for project management document control software are designed to organize project documentation to a named single project which filters into specifically named project logs. The documentation is normally listed in date chronological order and manually named by the user. These existing computer software programs fail to name the main contractor or listed subcontractors as a function for the main document organizing system, and this makes it difficult to search specific documentation pertaining to the main contractor or subcontractors. Therefore it requires more time to locate a required log item, resulting in less efficient project management and user frustration. The construction computer software market is without an exclusively developed construction project management document control software where on a per project basis, project logs and specialty reports can be linked directly to a main contractor and listed subcontractors in that project.

### SUMMARY OF THE INVENTION

However, through the invention of this document control computer software which may be called “CLS System” or the “Contractor Linked System”, this construction related computer software includes document control computer software serving the construction industry for general contractors, single prime contractors, subcontractors, private developers, and consulting project managers using a unique organizational computer software. This “Contractor Linked System” is a new and unique software program using over fifty document control logs and specialty reports all of which are linked to a named main contractor file in a computer memory or assigned to a listed subcontractor in a project to a computer memory. The construction computer software market is without an exclusively developed construction project management document control software where on a per project basis, project logs and specialty reports can be linked directly to a main contractor and listed subcontractors in that project. This “Contractor Linked System” computer software program invention is tailored for a contractor client to be used internally, strictly as a system for project management document controls regardless of the size of a construction project. By using the “Contractor Linked System” contractors no longer have to struggle to search or navigate through unrealistic software and now can manage construction project documentation that realistically meets the needs of construction professionals.

One or more embodiments of the present invention provide a method and/or an apparatus which implement construction related computer software. The construction related computer software typically concerns the constructing of new buildings, exterior renovations, interior renovations, single prime contractor specialty trade work, road construction, bridge construction and/or other structures including construction related trades but not limited to: (1) general conditions, (2) site work, (3) selective removals and demolition, (4) asbestos abatement, (5) lead abatement, (6) earthwork/excavation, (7) pile foundations, (8) asphalt paving, (9) sidewalk paving, (10) street paving, (11) concrete curbs and pavements, (12) storm drainage systems, (13) fences and gates, (14) outdoor game equipment, (15) indoor game equipment, (16) landscaping, (17) concrete, (18) masonry, (19) metals, (20) woods and plastics, (21) thermal and moisture protection, (22) doors and windows, (23) finishes, (24) equipment, (25) furnishings, (26) conveying systems, (27) plumbing/drainage, (28) heating ventilation and air conditioning, (29) electrical (30). hazardous material abatement (31) structural steel, and (32) ornamental metal.

In at least one embodiment of the present invention, the construction related computer software is configured for multiple contractor clients with the choice for each contractor client to create a single project or multiple projects with an unlimited user base at an affordable cost. In at least one embodiment of the present invention, the construction related computer software may include document control computer software serving the construction industry for general contractors, single prime contractors, subcontractors, private developers, and consulting project managers. The construction related computer software, in at least one embodiment of the present invention uses a unique organizational computer software system, which may be called the “CLS System” or the “Contractor Linked System”. In at least one embodiment, the “Contractor Linked System” uses over fifty document control logs and specialty reports all of which are linked to a named main contractor file in a computer memory or assigned to a listed subcontractor in a project to a computer memory.

This is not a “One Size Fits All” computer software program combining project management, cost accounting and scheduling as other construction software programs do. One or more embodiments of the present invention, include a computer software program for a contractor client to use internally, strictly as a system for project management document controls regardless of the size of a construction project.

In at least one embodiment, the present application provides an apparatus comprising a computer processor and a computer memory. The computer processor may be programmed to store in the computer memory, a name of a main contractor for a construction project. The computer processor may be programmed to store in the computer memory, one or more names for subcontractors for the construction project. The computer processor may be programmed to store in the computer memory, a main project folder for the construction project. The computer processor may be programmed to store in the computer memory, a main contractor folder for the construction project. The computer processor may be programmed to store in the computer memory, one or more subcontractor folders for the construction project.

The main contractor folder may include data relating to one or more responsibilities of the main contractor for the construction project. Each of the one or more subcontractor folders may include data relating to one or more responsibilities of a subcontractor to whom each of the one or more subcontractor folders belongs. The main project folder may include data which is also included in the main contractor folder and data which is also included in each of the one or more subcontractor folders.

The computer processor may be programmed to display a first dashboard image on a computer display, wherein the first dashboard image includes a first plurality of fields. The computer processor may be programmed to configure the first plurality of fields such that selection of a first field of the first plurality of fields causes data from the main project folder to be displayed on the computer display, selection of a second field of the first plurality of fields causes data from the main contractor folder to be displayed on the computer display, and selection of a third field of the first plurality of fields causes data from one of the one or more subcontractor folders to be displayed.

The computer processor may be programmed to display a second plurality of fields related to the main contractor folder, such that each of the second plurality of fields can be selected by a user to display a corresponding main contractor log related to a responsibility of the main contractor, such that there are a plurality of main contractor logs, one main contractor log for each of the second plurality of fields, each of the plurality of main contractor logs referring to a different responsibility for the main contractor.

The computer processor may be programmed to display one or more pluralities of fields related to each of the one or more subcontractor folders, such that each field of the one or more pluralities of fields can be selected by a user to display a subcontractor log related to a responsibility of each of the one or more subcontractors, such that there are one or more pluralities of subcontractor logs for each of the one or more subcontractor folders, wherein each subcontractor log for each plurality of subcontractor logs is different from every other subcontractor log in that plurality of subcontractor logs.

At least one embodiment of the present application includes a method comprising the steps of storing in a computer memory, a name of a main contractor for a construction project; storing in the computer memory, one or more names for subcontractors for the construction project; storing in the computer memory, a main project folder for the construction project; storing in the computer memory, a main contractor folder for the construction project; and storing in the computer memory, one or more subcontractor folders for the construction project.

The main contractor folder may include data relating to one or more responsibilities of the main contractor for the construction project. Each of the one or more subcontractor folders may include data relating to one or more responsibilities of a subcontractor to whom each of the one or more subcontractor folders belongs. The main project folder may include data which is also included in the main contractor folder and data which is also included in each of the one or more subcontractor folders.

The method may further include displaying a first dashboard image on a computer display, wherein the first dashboard image includes a first plurality of fields.

The first plurality of fields may be configured such that selection of a first field of the first plurality of fields causes data from the main project folder to be displayed on the computer display, selection of a second field of the first plurality of fields causes data from the main contractor folder to be displayed on the computer display, and selection of a third field of the first plurality of fields causes data from one of the one or more subcontractor folders to be displayed.

The method may further include displaying a second plurality of fields related to the main contractor folder, such that each of the second plurality of fields can be selected by a user to display a corresponding main contractor log related to a responsibility of the main contractor, such that there are a plurality of main contractor logs, one main contractor log for each of the second plurality of fields, each of the plurality of main contractor logs referring to a different responsibility for the main contractor.

The method may further include displaying one or more pluralities of fields related to each of the one or more subcontractor folders, such that each field of the one or more pluralities of fields can be selected by a user to display a subcontractor log related to a responsibility of each of the one or more subcontractors, such that there are one or more pluralities of subcontractor logs for each of the one or more subcontractor folders, wherein each subcontractor log for each plurality of subcontractor logs is different from every other subcontractor log in that plurality of subcontractor logs.

At least one embodiment of the present invention provides a computer readable medium comprising computer executable instructions which, when executed by a processor, perform one or more of the method steps previously discussed.

### BRIEF DESCRIPTION OF THE DRAWINGS

FIG. 1A shows a block diagram of an apparatus for a user computer for use in one or more embodiments of the present invention;

FIG. 1B shows a block diagram of an apparatus for a server computer for use in one or more embodiments of the present invention;

FIG. 2 shows a block diagram of a method for use in one or more embodiments of the present invention;

FIG. 3 shows a first image which is displayed on a computer display device of the user computer apparatus of FIG. 1A, in accordance with one or more embodiments of the present invention;

FIG. 4 shows a second image which is displayed on a computer display device of the user computer apparatus of FIG. 1A, in accordance with one or more embodiments of the present invention;

FIG. 5 shows a third image which is displayed on a computer display device of the user computer apparatus of FIG. 1A, in accordance with one or more embodiments of the present invention;

FIG. 6 shows a fourth image which is displayed on a computer display device of the user computer apparatus of FIG. 1A, in accordance with one or more embodiments of the present invention;

FIG. 7 shows a fifth image which is displayed on a computer display device of the user computer apparatus of FIG. 1A, in accordance with one or more embodiments of the present invention;

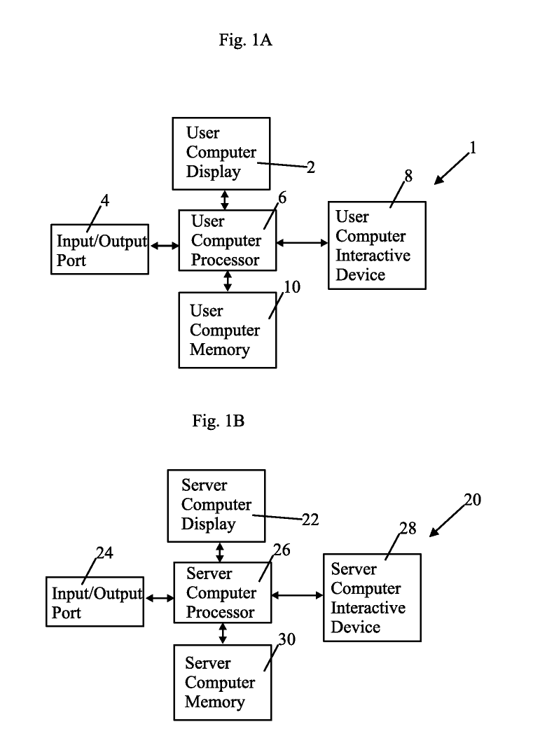

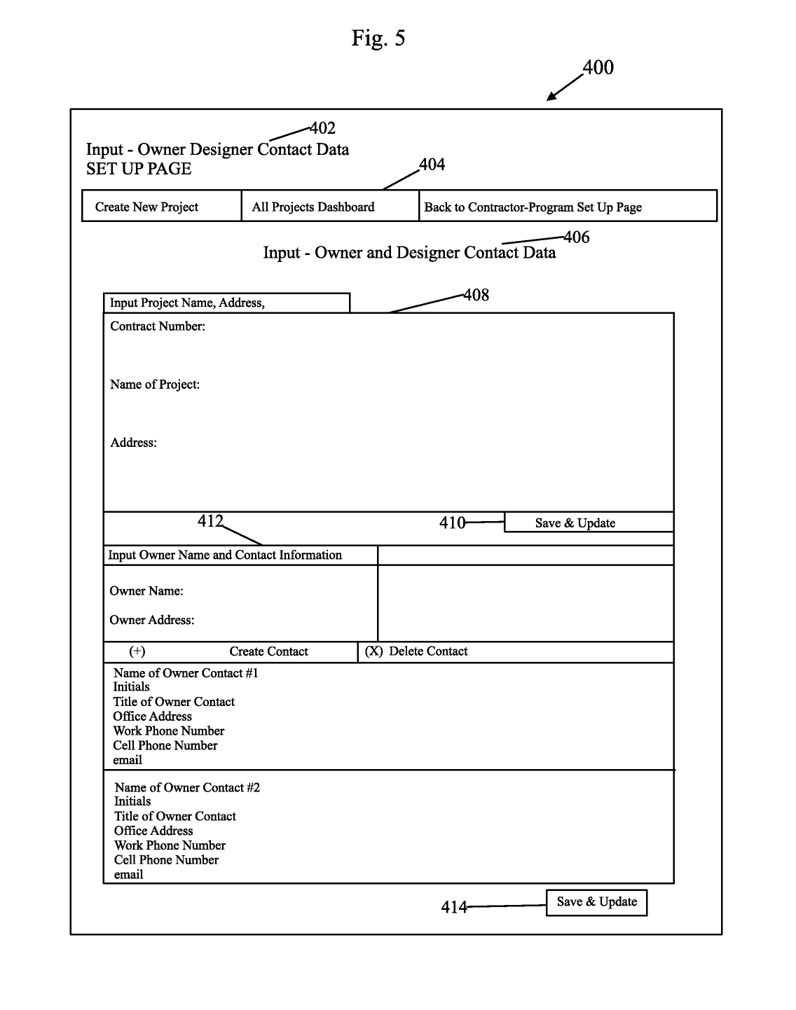

FIG. 5 shows a sixth image which is displayed on a computer display device of the user computer apparatus of FIG. 1A, in accordance with one or more embodiments of the present invention;

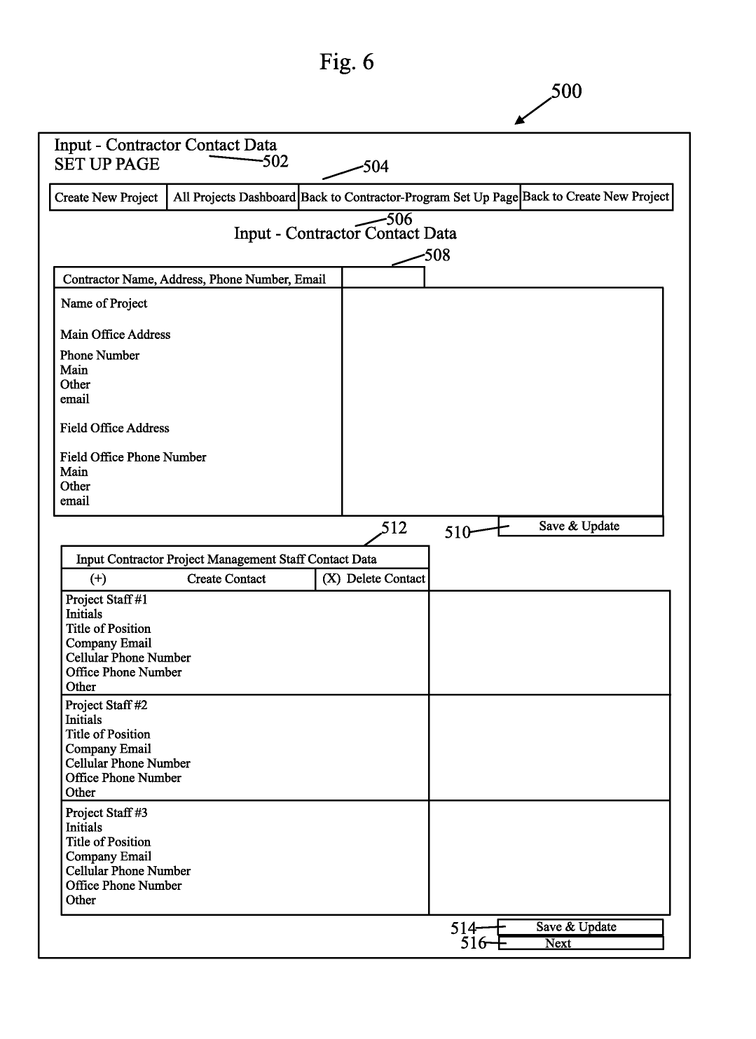

FIG. 6 shows a seventh image which is displayed on a computer display device of the user computer apparatus of FIG. 1A, in accordance with one or more embodiments of the present invention;

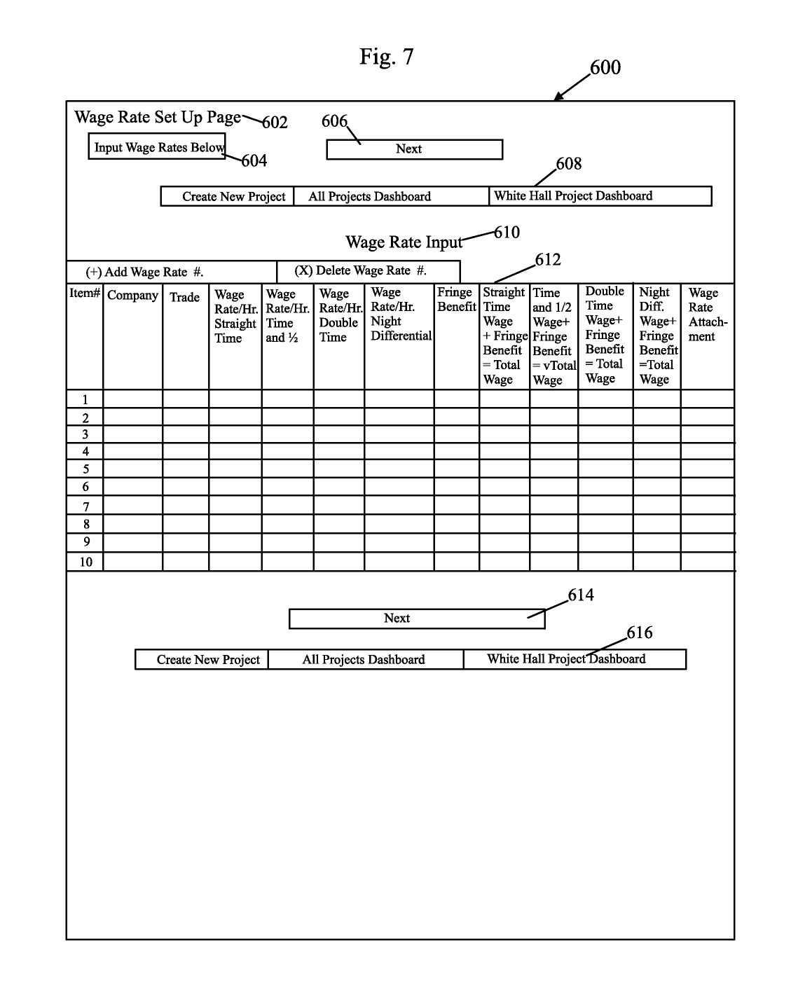

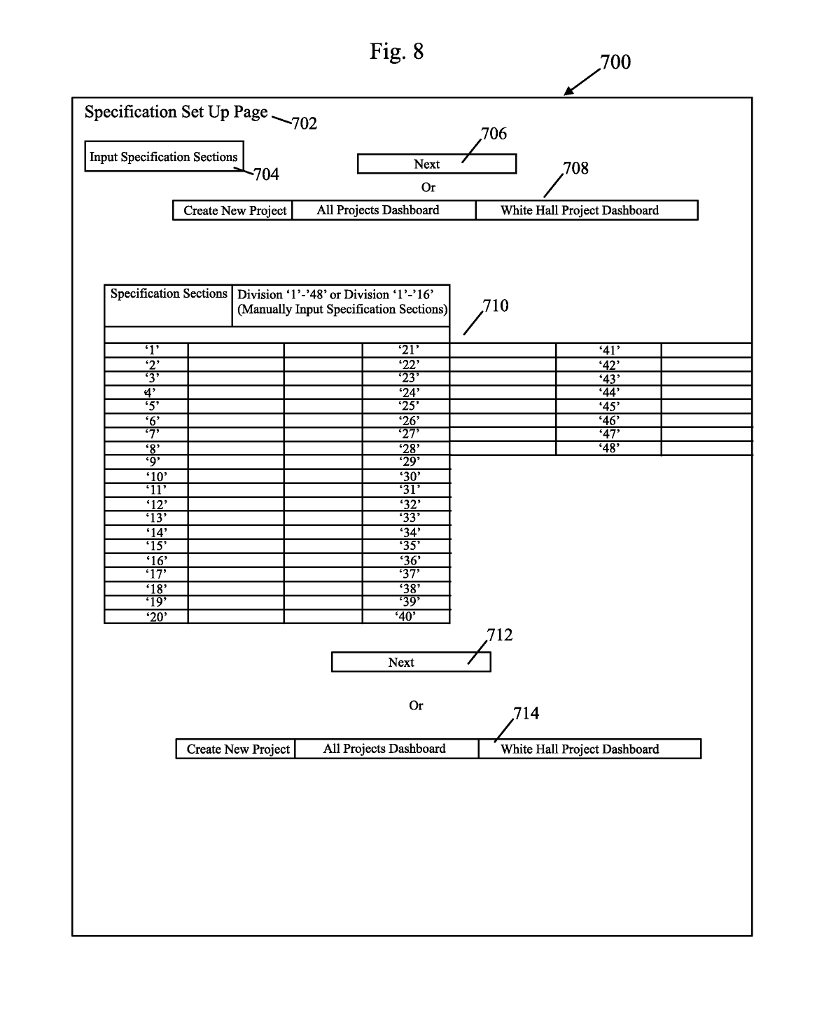

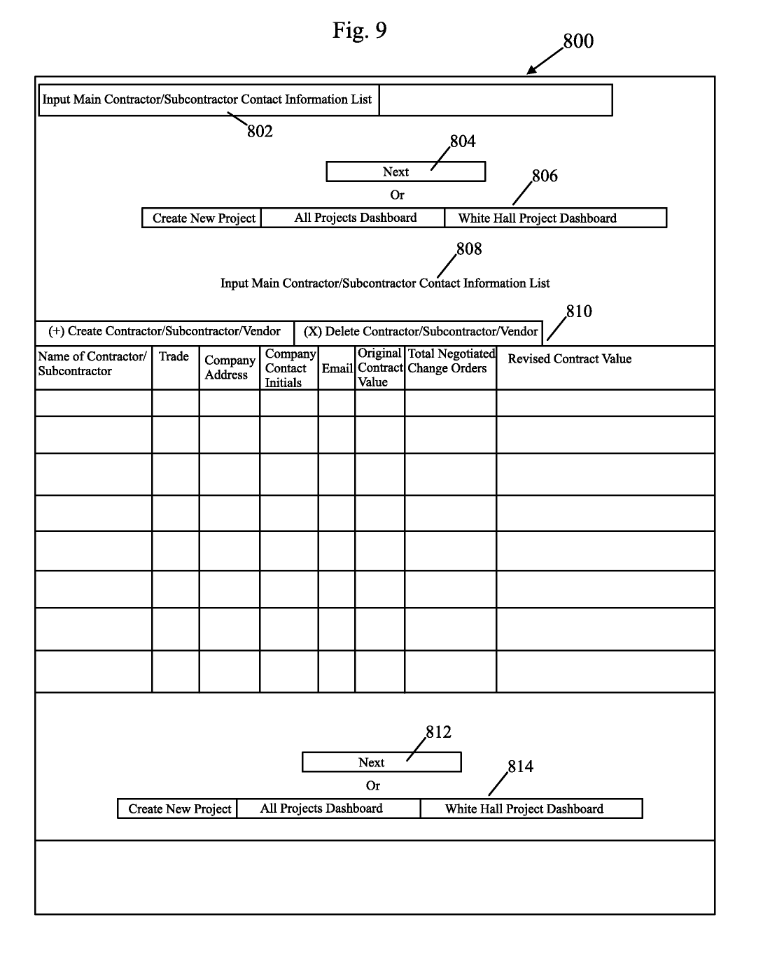

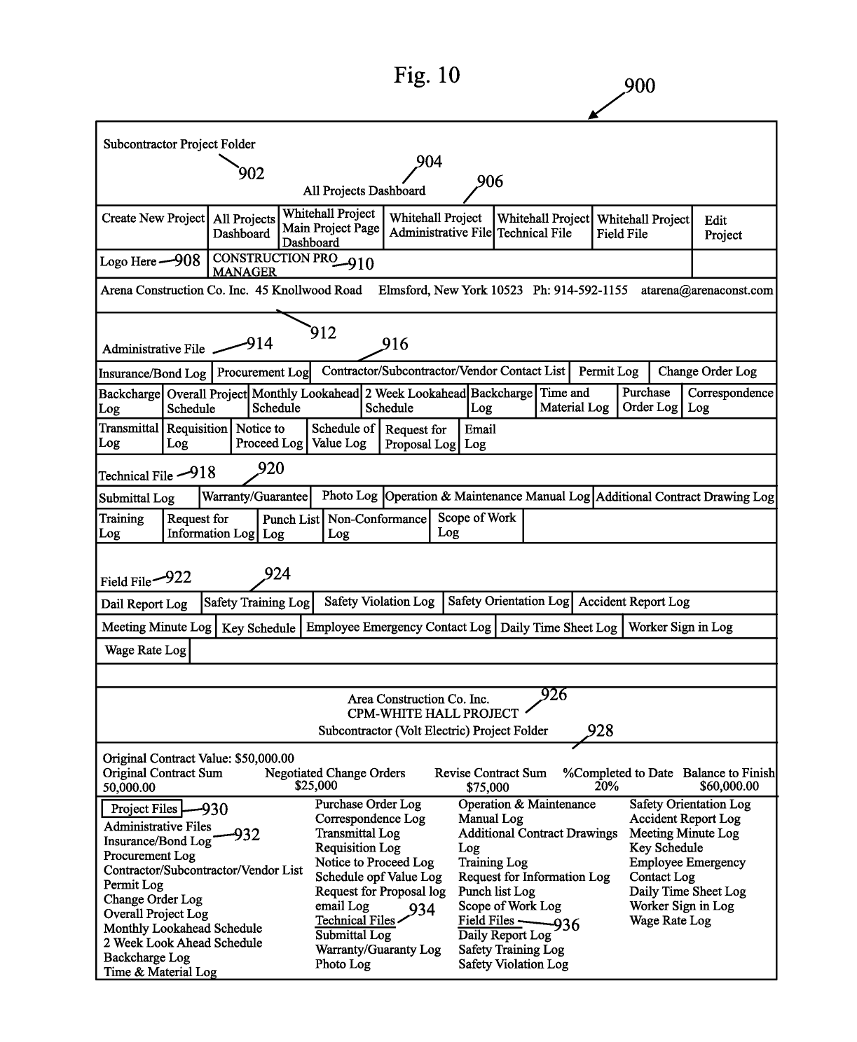

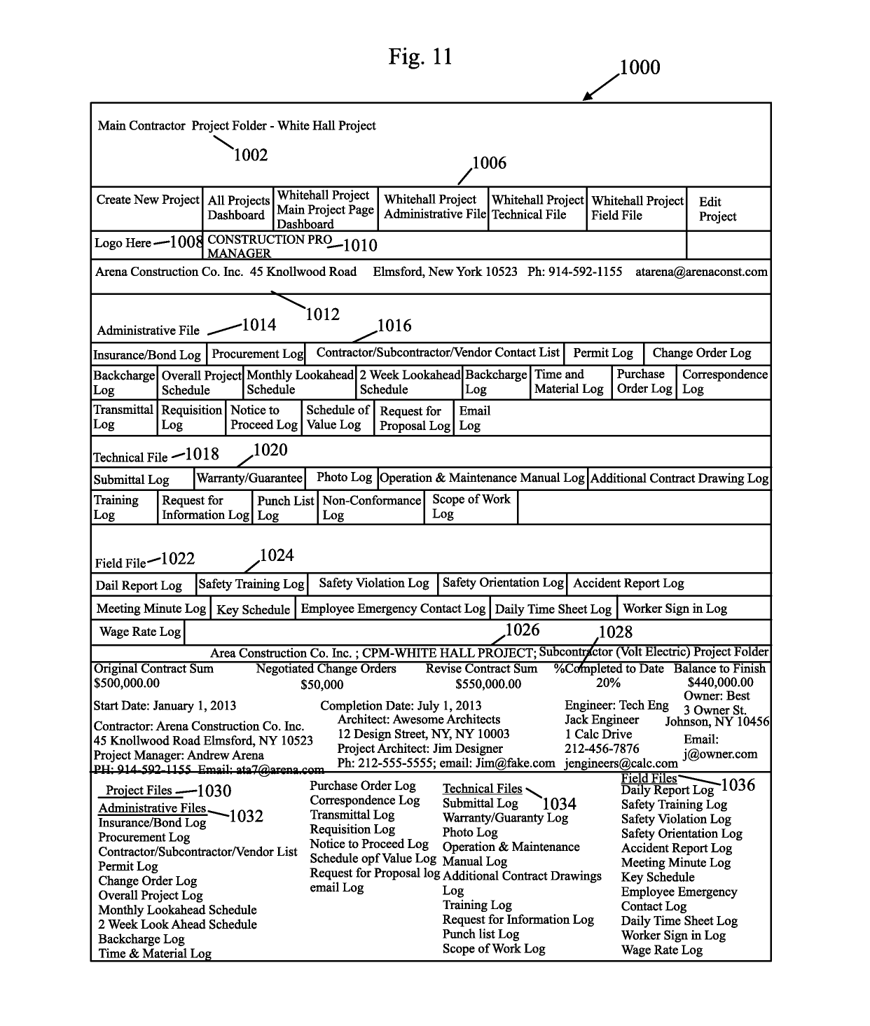

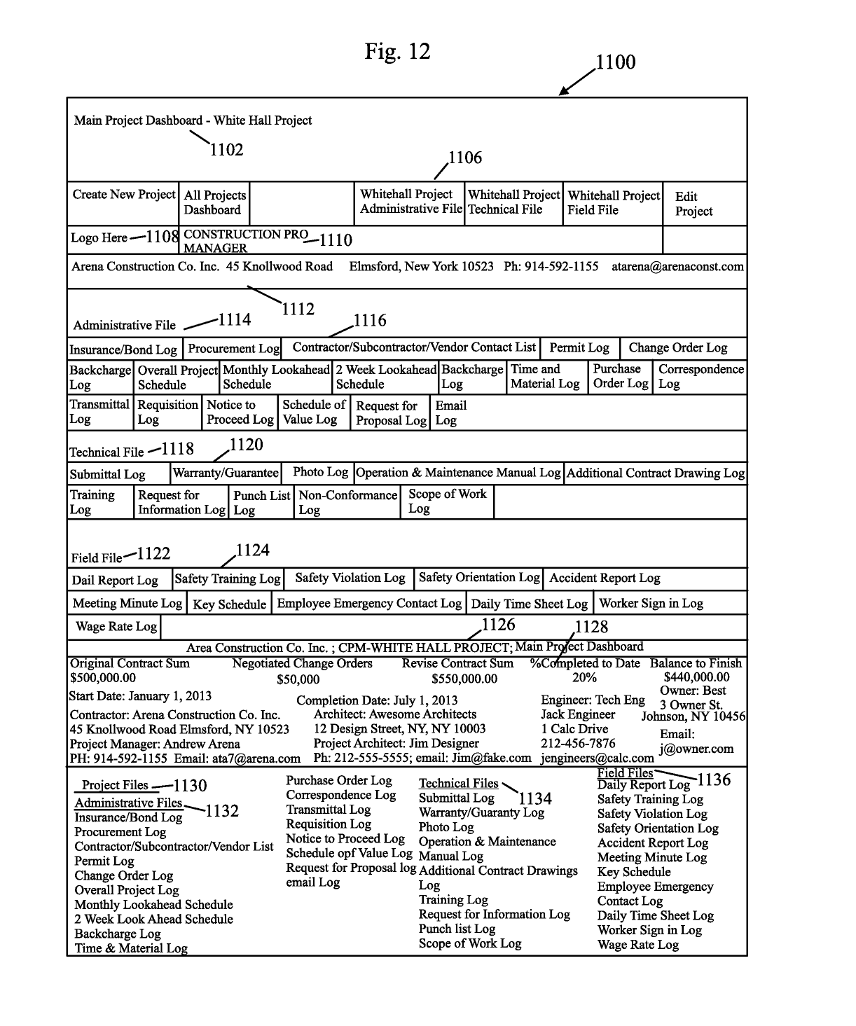

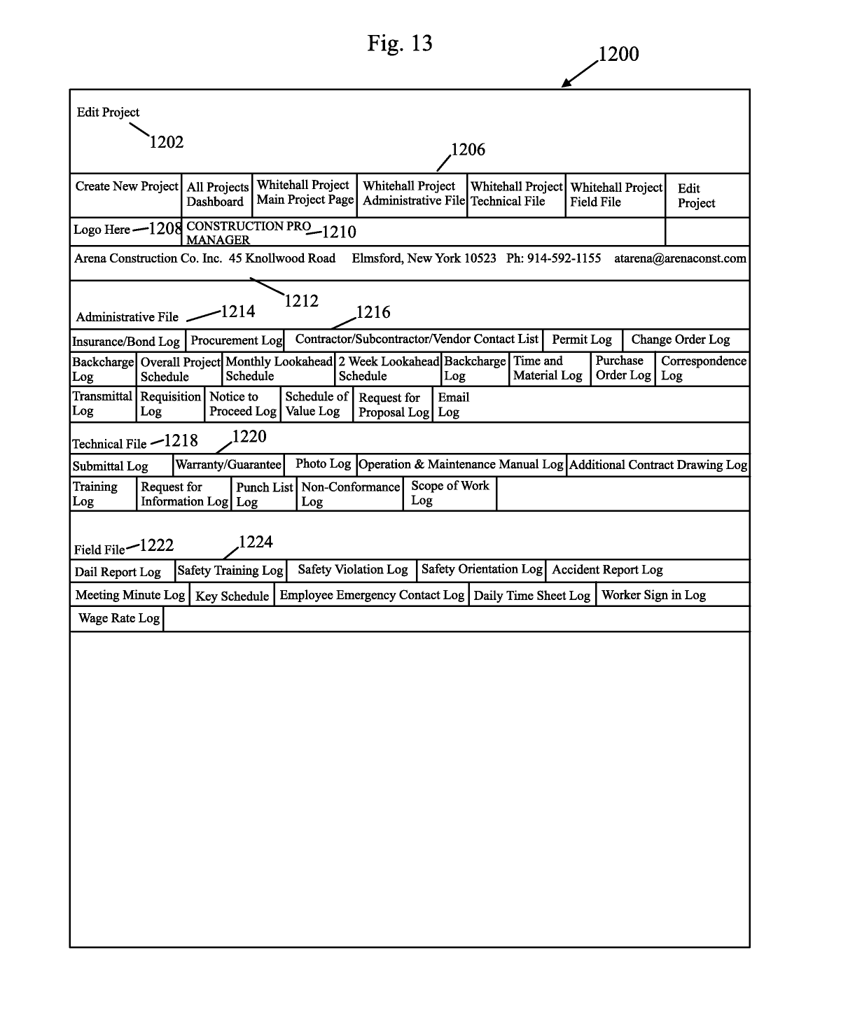

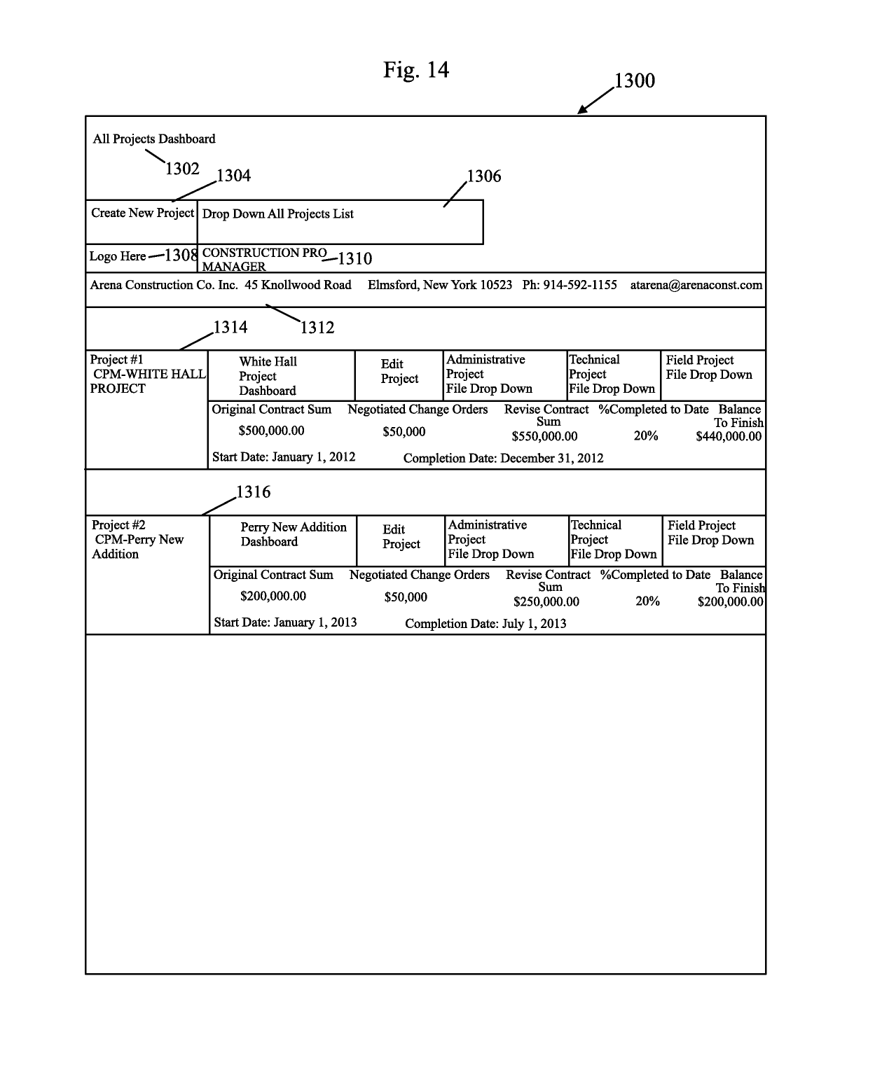

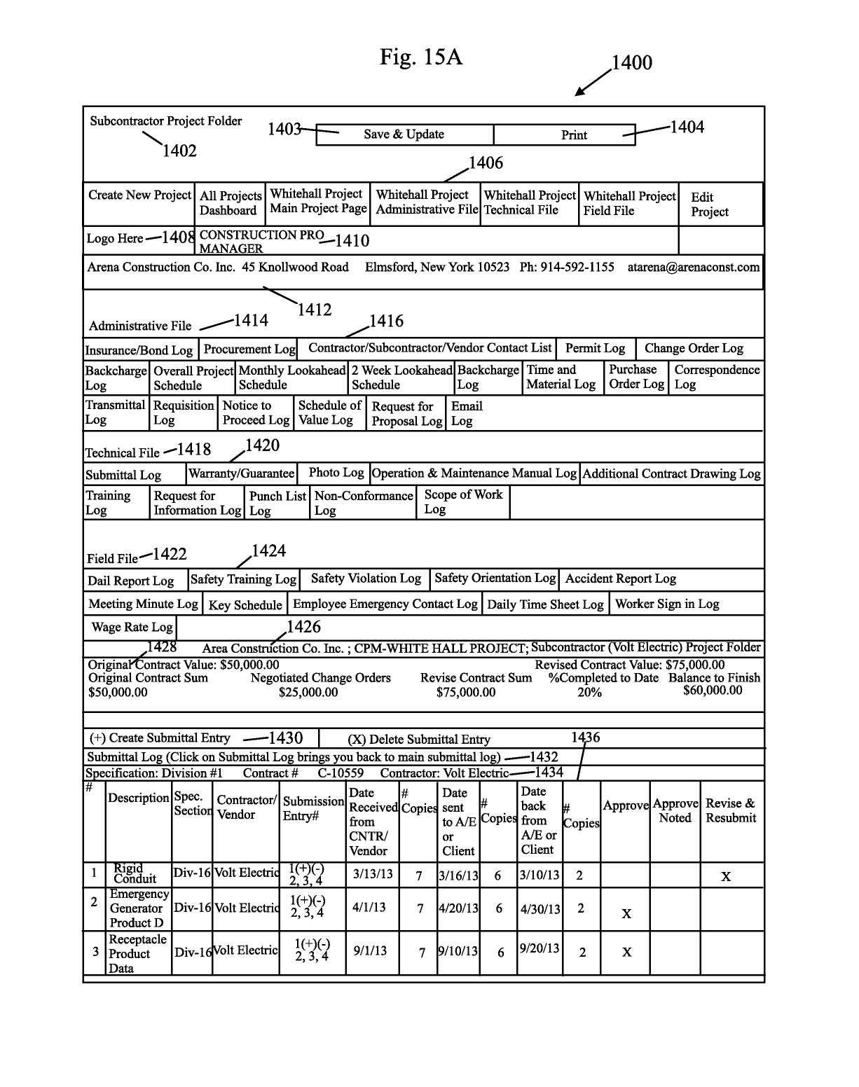

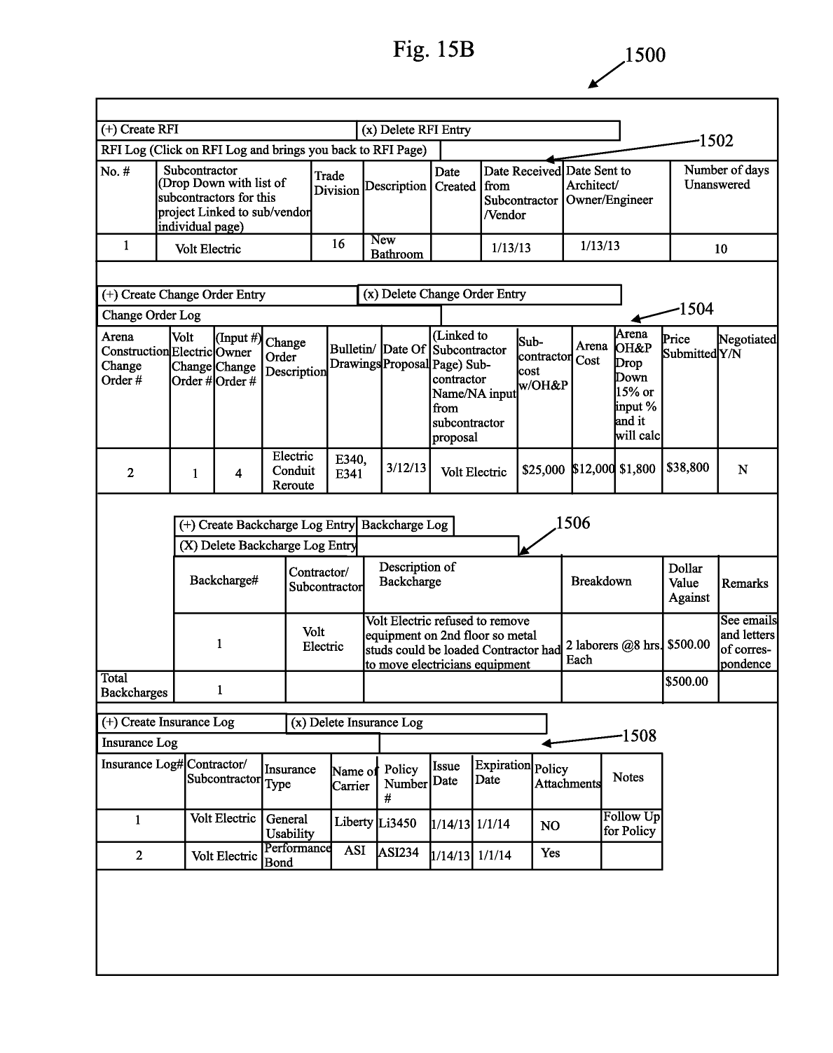

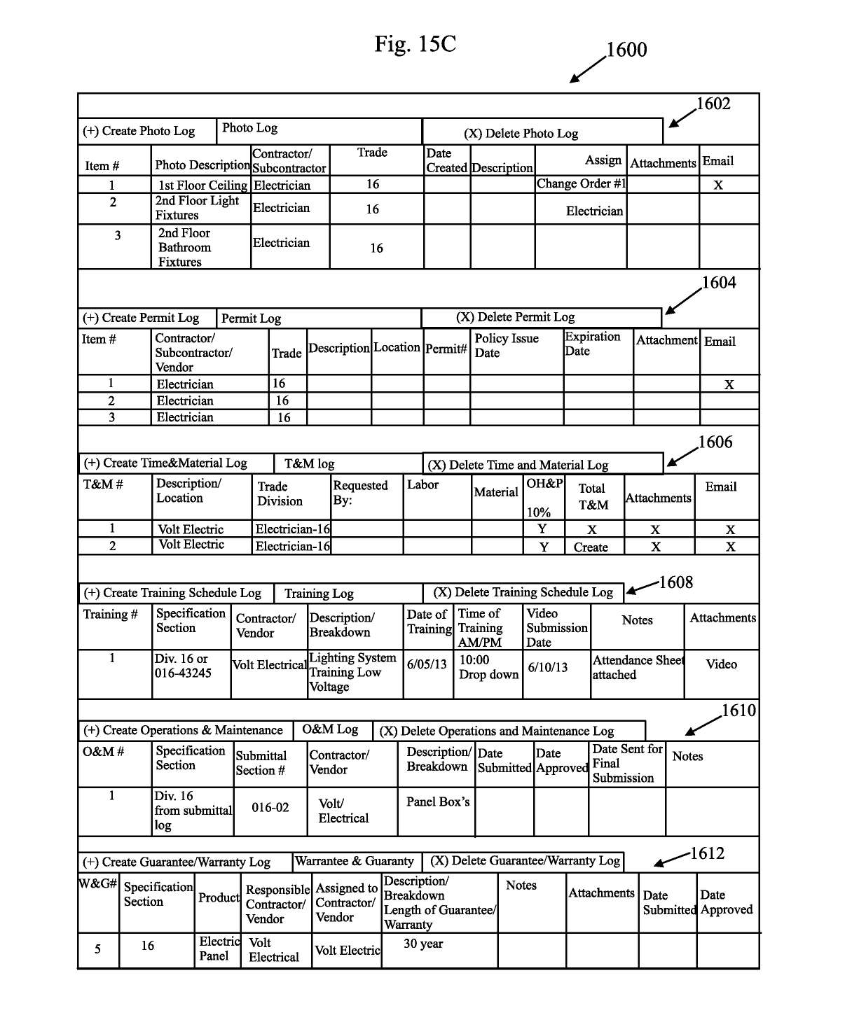

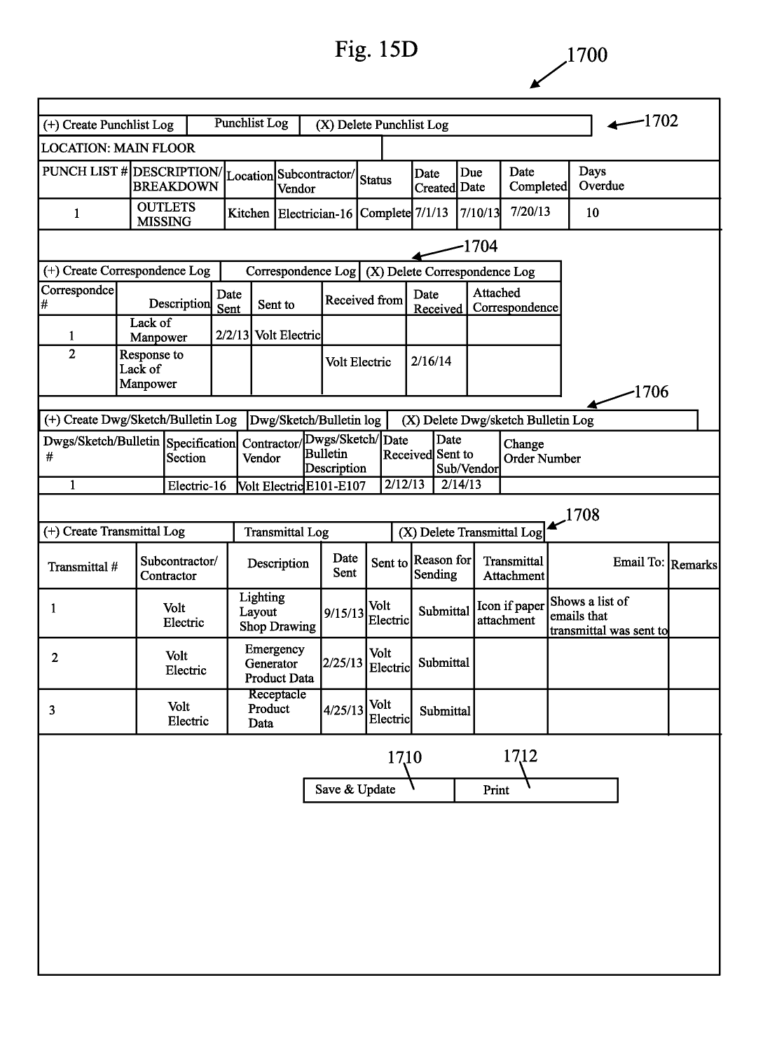

FIG. 7 shows a eighth image which is displayed on a computer display device of the user computer apparatus of FIG. 1A, in accordance with one or more embodiments of the present invention;

FIG. 7 shows a ninth image which is displayed on a computer display device of the user computer apparatus of FIG. 1A, in accordance with one or more embodiments of the present invention;

FIG. 8 shows a tenth image which is displayed on a computer display device of the user computer apparatus of FIG. 1A, in accordance with one or more embodiments of the present invention;

FIG. 9 shows an eleventh image which is displayed on a computer display device of the user computer apparatus of FIG. 1A, in accordance with one or more embodiments of the present invention;

FIG. 10 shows a twelfth image which is displayed on a computer display device of the user computer apparatus of FIG. 1A, in accordance with one or more embodiments of the present invention;

FIG. 11 shows a thirteenth image which is displayed on a computer display device of the user computer apparatus of FIG. 1A, in accordance with one or more embodiments of the present invention;

FIG. 12 shows an fourteenth image which is displayed on a computer display device of the user computer apparatus of FIG. 1A, in accordance with one or more embodiments of the present invention;

FIG. 13 shows an eleventh image which is displayed on a computer display device of the user computer apparatus of FIG. 1A, in accordance with one or more embodiments of the present invention;

FIG. 14 shows a twelfth image which is displayed on a computer display device of the user computer apparatus of FIG. 1A, in accordance with one or more embodiments of the present invention;

FIG. 15A shows a thirteenth image which is displayed on a computer display device of the user computer apparatus of FIG. 1A, in accordance with one or more embodiments of the present invention;

FIG. 15B shows an fourteenth image which is displayed on a computer display device of the user computer apparatus of FIG. 1A, in accordance with one or more embodiments of the present invention;

FIG. 15C shows a thirteenth image which is displayed on a computer display device of the user computer apparatus of FIG. 1A, in accordance with one or more embodiments of the present invention; and

FIG. 15D shows an fourteenth image which is displayed on a computer display device of the user computer apparatus of FIG. 1A, in accordance with one or more embodiments of the present invention.

### DETAILED DESCRIPTION OF THE DRAWINGS

FIG. 1A shows a block diagram of an apparatus 1 for a user computer for use in one or more embodiments of the present invention. The apparatus 1 may be a computer such as a personal computer, laptop computer, smart phone or tablet computer. The apparatus 1 may include a user computer display 2, an input/output port 4, a user computer processor 6, a user computer interactive device 8, and a user computer memory 10. The input/output port 4 may include a receiver and a transmitter for transmitting data. The input/output port 4 may include a port for connecting to the internet via a cable. The user computer interactive device 8 may include a user computer keyboard, a user computer mouse, and/or a user touch screen for inputting data into the user computer processor 6 via the user computer interactive device 8.

FIG. 1B shows a block diagram of an apparatus 20 for a server computer for use in one or more embodiments of the present invention. The apparatus 20 may be a computer such as a personal computer, laptop computer, smart phone or tablet computer. The apparatus 20 may include a server computer display 22, an input/output port 24, a server computer processor 26, a server computer interactive device 28, and a server computer memory 30. The input/output port 24 may include a receiver and a transmitter for transmitting data. The input/output port 24 may include a port for connecting to the internet via a cable. The server computer interactive device 28 may include a server computer keyboard, a server computer mouse, and/or a server touch screen for inputting data into the server computer processor 26 via the server computer interactive device 28.

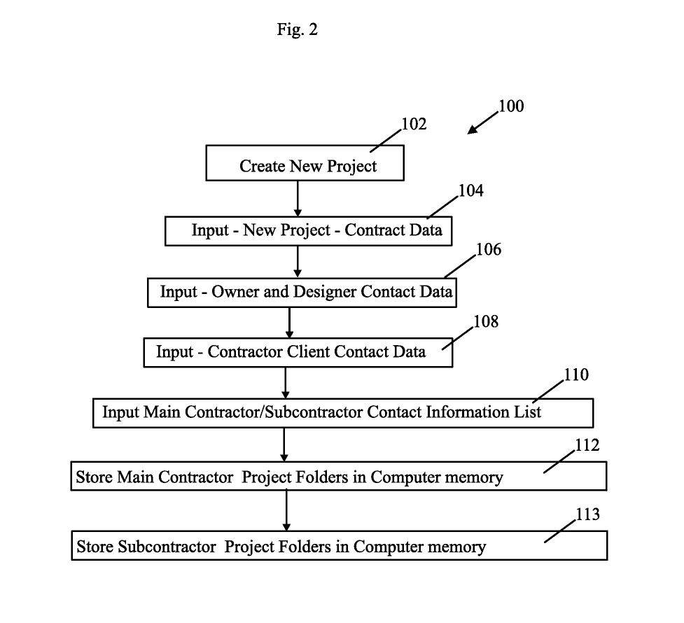

FIG. 2 shows a block diagram 100 of a method for use in one or more embodiments of the present invention. At step 102, a new project is created by a user, such as a client building contractor or person, through accessing a construction document computer program which may be accessed by the user computer 1 via the user computer processor 6, the input/output port 4, the input/output port 24, and the server computer processor 26. The construction document computer program may be stored in the server computer memory 30 and/or the user computer memory 10, and/or may be downloaded from the server computer memory 30 and then stored in the user computer memory 10 via the server computer processor 26, input/output ports 24 and 4, and the user computer processor 6. The construction computer program may be called a construction pro manager document control program. The construction computer program may be accessed via the internet, through input/output ports 4 and 24, through an online web site using the user computer apparatus 1 communicating with the server computer apparatus 20.

Also as part of step 102, the client contractor individual using computer apparatus 1 may next log on to the construction computer program of the web based server, or server computer apparatus 20, with a client contractor user identification and password. The server computer memory 30 may have stored there in a plurality of user identifications and corresponding passwords.

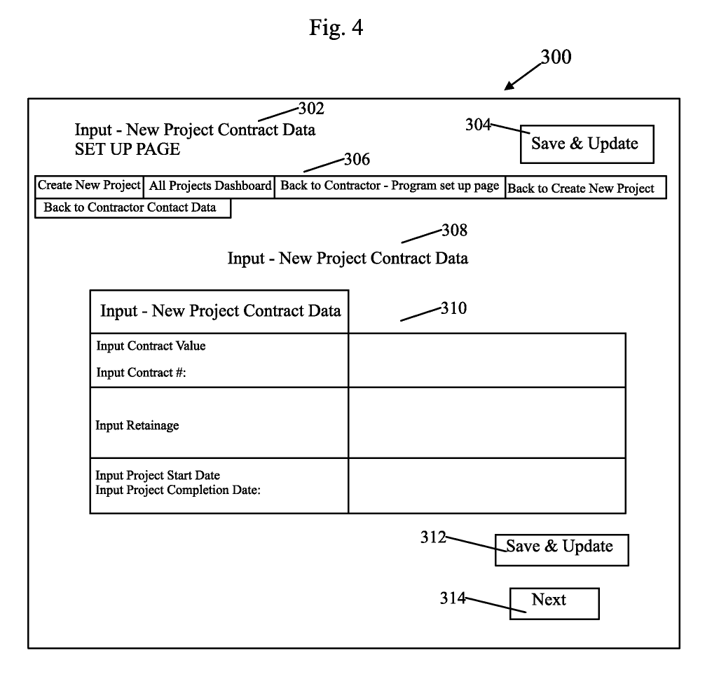

At step 104 of FIG. 2, contract data for a construction project is entered into the user computer processor 6 and/or the computer memory 10 by a user via the computer interactive device 8 or the input/output port 4, and the contract data is stored in the computer memory 10 by the computer processor 6. The contract data entered through step 104, may be entered via the image 300 shown in FIG. 4, by using user computer interactive device 8, such as through a touch screen computer display.

At step 106 owner and designer contact data for the construction project, referred to in step 104, is entered into the computer processor 6 and/or the computer memory 10 by a user via the computer interactive device 8 or the input/output port 4, and the owner and designer contact data is stored in the computer memory 10 by the computer processor 6. The owner and designer contact data entered through step 106, may be entered via the image 400 shown in FIG. 5, by using user computer interactive device 8, such as through a touch screen computer display.

At step 108 contractor client contact data for the construction project, referred to in step 104, is entered into the computer processor 6 and/or the computer memory 10 by a user via the computer interactive device 8 or the input/output port 4, and the contractor client contact data is stored in the computer memory 10 by the computer processor 6. The contractor client contact data for the construction project entered through step 108, may be entered via the images 500, 600, and 700, shown in FIGS. 6, 7, and 8, respectively, by using user computer interactive device 8, such as through a touch screen computer display.

At step 110 main contractor/subcontractor contract information list for the construction project, referred to in step 104, is entered into the computer processor 6 and/or the computer memory 10 by a user via the computer interactive device 8 or the input/output port 4, and the main contractor/subcontractor contract information list is stored in the computer memory 10 by the computer processor 6. The contractor client contact data for the construction project entered through step 110, may be entered via the image 800, shown in FIG. 8, respectively, by using user computer interactive device 8, such as through a touch screen computer display.

The main contractor/subcontractor information list provided at step 110, includes the names, business addresses, and contact information of the main contractor and affiliated subcontractors for the project referred to in steps 102 and 104, and the main contractor/subcontractor information list 110 may also include affiliated project management team contact information. The main contractor/subcontractor information list provided at step 110 may also include wage rate, trade data and original contract value pertaining to the main contractor and each subcontractor for the specific project referred to in steps 102 and 104.

A new project is typically created by the client contractor through accessing the a “Construction Pro Manager” document control program from an online web portal using user computer interactive device 8 through computer processor 6 and via input/output ports 4 and 24 accessing server computer processor 26. The next step, typically, is for the client contractor to log on to the web-based server computer 20, with a required client contractor user identification and password. Once the client contractor has logged on to their contractor dashboard, the client contractor creates the new project through selecting on the create new project icon 1304, shown in FIG. 14. After selecting the create new project 1304 shown in FIG. 14 using user computer interactive device 8 shown in FIG. 1A, four input functions refer to in steps 104, 106, 108 and 110 will be performed through manual input by the client contractor into the user computer interactive device 8, through the appropriate images, to gather required data pertinent to the new project.

A computer software program stored in the computer memory 10 and/or the server computer memory 30 and implemented by the computer processor 6 placed data for the new project in two locations in the computer memory 10 and/or 30 and stores information in the computer memory 10 indicating what the two locations are. Typically one location in computer memory 10 and/or 30 has stored therein a plurality of main contractor/subcontractor folders at step 112 and another location in computer memory 10 and/or 30 has stored therein a main project dashboard at step 113. The contents of the subcontractor folder and the main contractor folder are described in images 900 and 1000 of FIGS. 10 and 11, respectively. The contents of the main project dashboard are described in image 1100 of FIG. 12, respectively.

The location in computer memory 10 and/or 30 of the main project dashboard identified in image 1100 in FIG. 12 acts as a combined filing system location for the project implemented in steps 102 104, 106, 108, 110, 112, and 113 of FIG. 2. The computer processor 6 is programmed by a computer program stored in computer memory 10 to automatically create the main contractor/subcontractor contact information list 110. After the main contractor/subcontractor contact information list 110 has been created in computer memory 10 and/or 30 the next step is for the main contractor/subcontractors contact information list 110 to be assigned to the main contractor project folders 112 and/or subcontractor project folders 113, shown in the image 1100 of FIG. 12 along with three project files including (a) an administrative file, such as shown by 914-916 or 1014-1016 in FIGS. 10-11, respectively, (b) a technical file such as shown by 918-920 and 1018-1020 in FIGS. 10-11, respectively, (c) a field file, such as shown by 922-924 or 1022-1024 in FIGS. 10-11, respectively. These three project files (administrative, technical and field), in at least one embodiment, combine over fifty document control logs and reports which are stored in computer memory 10 and/or 30, listing all documentation pertaining to the main contractor and subcontractors. This filing system organizes each log item in chronological date order, such as shown in FIGS. 15A-D.

The second of the two locations in the computer memory 10 and/or 30 where the new project is assigned may be called the CLS Main Contractor/Subcontractor Project Folders and may be stored at step 112 of FIG. 2. The computer processor 6 may be programmed to store the listed main contractor data in computer memory 10 and/or computer memory 30, as shown by image 1000 in FIG. 11, at step 112 of FIG. 2 and subcontractors created by the computer processor 6 from the “CLS—Main Contractor/Subcontractor Contact Information List” in step 110 then the computer processor 6 transfers the main contractor and subcontractors individual data from the “CLS—Main Contractor/Subcontractor Contact Information List” in step 110 into the “CLS—Main Contractor/Subcontractor Project Folders”. The location in computer memory 10 for the CLS-Main Contractor/Subcontractor Project Folders is the location where the main contractor and subcontractors receive their individual project page folders.

Similar to the “Main Project Dashboard”, in the Main Contractor/Subcontractor folders in computer memory 10 and/or 30 there are three project files: (1) administrative File, (2) technical file, and 3) field file, assigned to the main contractor and to each subcontractor listed. Throughout the life of the project, whether data be input from the “Main Project Dashboard” image 1100, shown in FIG. 12, through use of user computer interactive device 8, into the computer memory 10 and/or 30, or the CLS—Contractor/Subcontractor Project Folders”, through image 1000 and/or 900, shown in FIGS. 11 and 10, respectively, it is each log in the three project files that is always assigned to the name of either the main contractor or subcontractors with their assigned trades. When inputting data into a log, such as field 1430 submittal log of FIG. 15A it is a mandatory function that the contractor's name and trade is input. As stated above, this function can be input from either the image 1100 “Main Project Dashboard” or the images 900 or 1000 of the “CLS—Contractor/Subcontractor Project Folders”, which then initiates the Contractor Linked System (CLS). Without the name and trade of the main contractor and subcontractors inputted into each log, the “CLS-Contractor Linked System” cannot function and unable to track and link the project logs to the assigned contractor. In at least one embodiment, the “CLS-Contractor Linked System” must have the name of the main contractor or subcontractor input into the software program from FIG. 9 field 810, FIG. 10 field 916, FIG. 11 field 1016, FIG. 12 field 1116, image 1000 through a computer interactive device, such as computer interactive device 8, linked from FIG. 2 of the 110 “Main Contractor/Subcontractor Information List”.

At any time during the project the client contractor can add a subcontractor or delete a subcontractor using an “Edit Project” function, through image 1200 by use of computer interactive device 8. However, once a subcontractor is deleted from the project the “CLS-Contractor Linked System”, in at least one embodiment, as implemented by the computer processor 6 in accordance with computer software stored in computer memory 10, will no longer recognize this subcontractor in the software program and all logs and reports pertaining to this subcontractor shall be permanently deleted from the Main Project Dashboard and the CLS—Main Contractor/Subcontractor Project Folders in at least one embodiment of the present invention. In addition, the client contractor has the ability through the same “Edit Project” function of image 1200 shown in FIG. 13, to edit any contractual and contact information as it pertains to the individual project or the main contractor and subcontractors.

At step 112, the computer processor 6 is programmed to store the data entered in steps 104, 106, 108, and 110 in main contractor/subcontractor project folders in computer memory 10 and/or computer memory 30, for this single project alone. Multiple projects may be stored in computer memory 10 and listed in the All Projects Dashboard shown in image 1300 shown in FIG. 14 for access to other created projects. All projects stand alone and may always be created by beginning with the create new project 102 function.

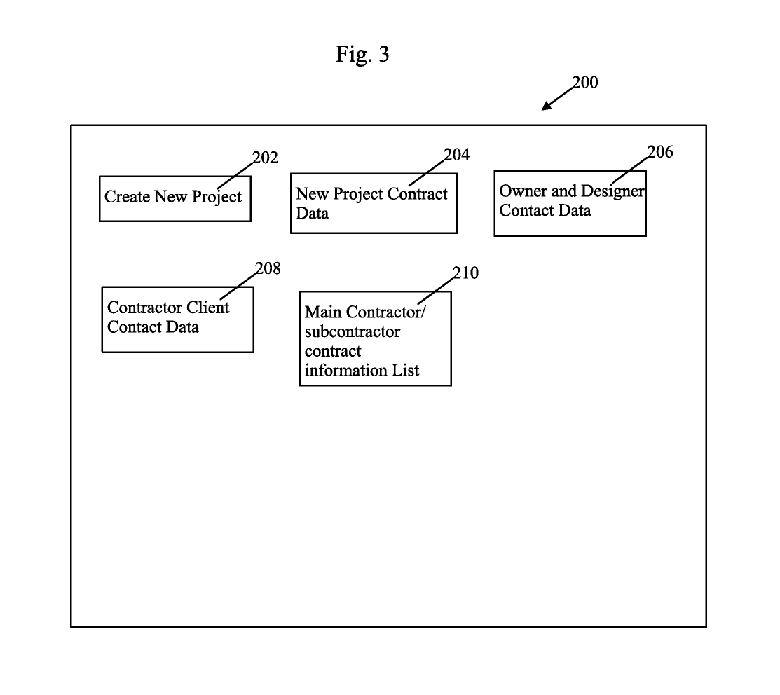

Once the client contractor individual has logged on to the construction computer program, the server computer processor 26 is programmed to send the user computer processor 6 an image of a contractor dashboard, which is then displayed on the user computer display 2. An example of a image of a contractor dashboard is shown as image 200 in FIG. 3.

The contractor dashboard image 200 in FIG. 3 includes a field labeled “Create New Project” 202. The “Create New Project” field 202 can be selected by a user using user computer interactive device 8 of the user computer apparatus 1. After the field 202 has been selected field 300 in FIG. 4 appears on the computer display 2. The contractor then inputs the new project contract data in field 310. The contractor dashboard image 200 also includes field “New Project Contract Data” 204, field “Owner and Designer Contact Data” 206, and “Contractor Client Contact Data” 208 and field “Main Contractor/subcontractor Contact Information List” 210. A user can select any of 204, 206, 208, or 210 using user computer interactive device 8 of the user computer apparatus 1, such as by clicking on with a computer mouse or touching a computer screen. When a user selects the “New Project Contract Data” field 204 in FIG. 3, an image 300 shown in FIG. 4, is displayed on the user computer display 2 by the user computer processor 6, in accordance with a computer program stored in the server computer memory 30 and/or the user computer memory 10.

The image 300 in FIG. 4 includes text 302, field 304, dashboard fields or buttons 306, text 308, chart 310, field 312, and field 314. The text 302 indicates that new project contract data is to be entered in a setup page. The field 304 can be selected by a user using user computer interactive device 8 to save and/or update the data entered into chart 310. The dashboard fields or buttons 306 include a plurality of fields in a plurality of boxes, each of which can be selected. Selecting “Create New Project” of the dashboard 306 using computer interactive device 8, allows the user to create a new project with different project contract data such as shown in FIG. 4 and new owner designer contact data, such as shown in FIG. 5. Selecting “All Projects Dashboard” of the dashboard 306 using device 8, allows the user to access FIG. 14 “All Projects Dashboard” or image 1300 shown in FIG. 14 which displays all of the projects created under this particular client contractor. This allows the user to return to a project previously created. Selecting “Back to Contractor—Program set up page” of the dashboard 306 using device 8, allows the contractor to return to the image 200 in FIG. 3 to access fields 202, 204, 206, 208, and 210 of image 200. Selecting “Back to Create New Project” of the dashboard 306 using device 8, allows the contractor to create an entirely different project separate from the present project being created. This function allows the user to exit image 300 and return to FIG. 3, field 202 of which then returns to FIG. 4 and blank image 300. Selecting “Back to Contractor Contact Data” of the dashboard 306 using device 8, allows the user to return to FIG. 5 field 400 to edit any data from prior input.

A user using user interactive device 8 can enter into the chart 310, an input contract value and an input contract number next to the text designations for those items in chart or table 310. A user using interactive device 8 can also enter into the chart 310, and input a retainage value (which represents a percentage portion of a contractor's payment withheld until a project is complete), an input project start date, and an input project completion date into the chart 310. A user can save the entries entered into the chart or table 310 into the computer memory 10 and/or the computer memory 30 by selecting the “save & update” field 312 using user interactive device 8. A user can cause a different page or image to be displayed on the user computer display 2 by selecting the “Next” field 314 using user interactive device 8.

FIG. 5 shows an image 400 which is displayed on the computer display device 2 of the user computer apparatus 1 of FIG. 1A, in accordance with one or more embodiments of the present invention. The computer processor 6 and/or the computer processor 26 causes the image 400 to be displayed in response to selection of field 206 shown in FIG. 3, by a user using user interactive device 8 of the user computer apparatus 1 shown in FIG. 1A.

The image 400 includes text 402 for “Input—Owner Designer Contact Data” and “SET UP PAGE”. The image 400 also includes fields 404 which include a “Create New Project” field, a “All Projects Dashboard” field, and a “Back to Contractor-Program Set Up Page” field. Selecting “Create New Project” of the dashboard 404 using computer interactive device 8, allows the user to create an entirely new project with different project contract data as shown for example in FIG. 4 and new owner designer contact data, as shown in FIG. 5. Selecting “All Projects Dashboard” of the dashboard 404 using device 8, allows the user to access the FIG. 14 “All Projects Dashboard” which displays all of the projects created under this particular client contractor. This allows the user to return to a project previously created. Selecting “Back to Contractor—Program set up page” of the dashboard 404 using device 8, allows the contractor to return to the image 200 in FIG. 3 to access fields 202, 204, 206, 208, and 210 of image 200.

The image 400 also includes text 406 for “Input—Owner and Designer Contact Data”. The image 400 also includes a chart 408 into which a contract number, a name of project and an address of project can be entered by a user using user interactive device 8. The image 400 also includes a field 410 for “Save & Update” which when selected causes the information entered in chart 408 to be saved in user computer memory 10 and/or server computer memory 30.

The image 400 also includes a chart 412 having text “Input Owner Name and Contact Information” and allowing the input of an owner name and owner address using the computer interactive device 8 into the computer memory 10 and/or the server computer memory 30.

The chart 412 also includes row with one plus sign “+” “Create Contact”, such that a contact can be created by selecting on the plus “+” sign. This creates a new owner contact in field 412 allowing the user to input initials, title of owner contact, office address, phone numbers, and email address. The chart 412 also includes an “X” before “Delete Contact” which can be selected by a user using computer interactive device 8 to delete a contact. The chart 412 also shows the names of owner contact #1 and name of owner contact #2 and various information regarding that. The image 400 further includes a field 414 which can be selected using user interactive device 8 to save and update the information in the chart 412 in the user computer memory 10 and/or the server computer memory 30.

FIG. 6 shows an image 500 which is displayed on the computer display device 2 of the user computer apparatus 1 of FIG. 1A, in accordance with one or more embodiments of the present invention. The computer processor 6 and/or the computer processor 26 causes the image 500 to be displayed in response to selection of field 208 shown in FIG. 3, by a user using user interactive device 8 of the user computer apparatus 1 shown in FIG. 1A.

The image 500 includes text 502 for “Input—Contractor Contact Data” and “SET UP PAGE”. The image 500 also includes fields 504 which include a “Create New Project” field, a “All Projects Dashboard” field, a “Back to Contractor-Program Set Up Page” field, and a “Back to Create New Project” field. Selecting “Create New Project” of the dashboard 504 using computer interactive device 8, allows the user to create a new project with different project contract data, such as shown in FIG. 4 and new owner designer contact data such as shown in FIG. 5. Selecting “All Projects Dashboard” of the dashboard 504 using device 8, allows the user to access FIG. 14 “All Projects Dashboard” which displays all of the projects created under this particular client contractor. This allows the user to return to a project previously created. Selecting “Back to Contractor—Program set up page” of the dashboard 504 using device 8, allows the contractor to return to the image 200 in FIG. 3 to access fields 202, 204, 206, 208, and 210.

The image 500 also includes text 506 for “Input—Contractor Contact Data”. The image 500 also includes a chart 508 into which a contractor name, address, phone number and email can be entered by a user using user interactive device 8. A name of a project, such as a building or construction project, can be entered and a main office address, main office phone number, other phone number and email for a contractor can be entered into chart or table 508 and then the processor 6 and/or 26 is programmed to stored the information entered into table 508 into the computer memory 10 and/or 30. A field office address, field office main phone number and other phone number, and a field office email address can also be entered into the chart 508 and then stored by the processor 6 and/or 26 into the computer memory 10 and/or 30. The information entered into chart 508 is stored in response to selection of the save and update field 510 by use of user computer interactive device 8.

The image 500 also includes a chart 512 into which a contractor project management staff contact data can be entered by a user using user interactive device 8. For example, data for a project staff persons #1, #2, and #3, including initials, title of position, company email, cellular phone number, office number, and other data for each of these project staff persons can be entered into the chart 512 and then stored by the processor 6 and/or the processor 26 into the computer memory 10 and/or 30. The information entered into chart 512 is stored in response to selection of the save and update field 514 by use of user computer interactive device 8. The table 512 also includes fields for “Create Contact” to allow the particular project staff number person contact to be created and “Delete Contract” to allow the particular project staff number person to be deleted in the computer memory 10 and/or 30 by the processors 6 and/or 26 as programmed by a computer program stored in computer memories 10 and/or 30. The specific project staff person data can be highlighted and then the “X” next to Delete Contract can be selected to delete the data regarding the specific project staff person in chart 512. The chart 512 also includes row with one plus sign “+” “Create Contact” which can be selected by selecting on the plus “+” sign. This creates a new owner contact in field 512 allowing the user to input initials, title of owner contact, office address, phone numbers, and email address.

The field for “Next” in image 500 can be selected using user computer interactive device 8 to go to or display the next image shown in FIG. 7 “Wage Rate Set Up Page” on the computer display 22.

FIG. 7 shows an image 600 which is displayed on the computer display device 2 of the user computer apparatus 1 of FIG. 1A, in accordance with one or more embodiments of the present invention. The computer processor 6 and/or the computer processor 26 causes the image 600 to be displayed in response to selection of FIG. 6 field 516, and first selecting the “Edit Project” drop down menu and then selecting “Wage Rate Set Up Page” in FIG. 10 field 906, FIG. 11 field 1006, FIG. 12 field 1106, FIG. 13 field 1206, FIG. 14 field 1314, by a user using user interactive device 8 of the user computer apparatus 1 shown in FIG. 1A.

The image 600 includes text 602 for “Wage Rate Set Up Page”. The image 600 also includes text 604 for “Input Wage Rates Below”. The image 600 also includes field 606 for “Next” when selected the field for “Next” in image 600 can be selected using user computer interactive device 8 to go to or display the next image shown in FIG. 8, “Specification Set Up Page” on the computer display 22. The image 600 also includes a plurality of fields 608, “Create New Project”, “All Projects Dashboard”, “White Hall Project Dashboard”. Selecting “Create New Project” of the dashboard 608 using computer interactive device 8, allows the user to create a new project with different project contract data, such as shown in FIG. 4 and new owner designer contact data for FIG. 5. Selecting “All Projects Dashboard” of the dashboard 608 using device 8, allows the user to access FIG. 14 “All Projects Dashboard” which displays all of the projects created under this particular client contractor. This allows the user to return to a project previously created. When selected, “White Hall Project Dashboard” of the dashboard 608 using device 8, allows the user to return to access the “White Hall Project Dashboard”. This function allows the user to access and input pertinent project documentation under this project.

The image 600 also includes text 610 for “Wage Rate Input”. The image 600 also includes chart or table 612. The chart or table 612 includes a section or field which states “Add Wage Rate #.” and which has a “(+)” symbol next to it which can be selected by a user using user computer interactive device 8 to add or enter wage rate information into table 612 which is then stored in the computer memory 10 and/or the computer memory 30 by the computer processor 6 and/or the computer processor 26 in accordance with a computer program stored in computer memories 10 and/or 30. The chart 612 includes a first column labeled “Item #” which indicates the wage rate item # in chronological order of input.

The chart 612 includes a second column labeled “Company” and a company name of a contractor can be entered in a cell or box under the “Company” column, in any of the rows of items “1”-“10” in chart 612, for any one of ten different companies for example. The chart 612 includes a third column labeled “Trade”; and a trade for the particular item or company can be entered in the appropriate cell or box in the third column. The chart 612 includes a fourth column labeled “Wage Rate/Hr. Straight Time”; and a wage rate per hour for straight time can be entered for the particular item or company into the appropriate cell or box in the fourth column. The chart 612 includes a fifth column labeled “Wage Rate/Hr. Time and ½”; and a wage rate per hour for time and a half can be entered into the appropriate cell or box in the fifth column.

The chart 612 includes a sixth column labeled “Wage Rate/Hr. Double Time”; and a wage rate per hour for double time can be entered into the appropriate cell or box in the sixth column. The chart 612 includes a seventh column labeled “Wage Rate/Hr. Night Differential”; and a wage rate per hour night differential can be entered into the appropriate cell or box in the seventh column. The chart 612 includes an eighth column labeled “Fringe Benefit”; and fringe benefits can be entered into the appropriate cell or box in the eighth column. The chart 612 includes a ninth column labeled “Straight Time Wage+Fringe Benefit=Total Wage”; and that total can be entered into the appropriate cell or box in the ninth column. The chart 612 includes a tenth column labeled “Straight Time and ½ Wage+Fringe Benefit=Total Wage”; and that total can be entered into the appropriate cell or box in the tenth column. The chart 612 includes an eleventh column labeled “Double Time Wage+Fringe Benefit=Total Wage”; and that total can be entered into the appropriate cell or box in the eleventh column. The chart 612 includes a twelfth column labeled “Night Diff. Wage+Fringe Benefit=Total Wage”; and that total can be entered into the appropriate cell or box in the twelfth column. The chart 612 includes a thirteenth column labeled “Wage Rate Attach-ment”; and that information is provided from a company serving as saved reference documentation to represent the wage rate inputted in field 612. This is to be stored as an attachment. This attachment can be entered into the appropriate cell or box in the thirteenth column.

Information can be entered into the cells or boxes of the chart 612 using user computer interactive device 8 and thereby stored in the computer memory 10 and/or 30 using computer processors 6 and 26.

The image 600 further includes a field 614 for “Next” which can be selected using user computer interactive device 8 to enter the information entered into the cells of the chart 612 into the computer memory 10 and/or the computer memory 30 using the computer processor 6 and/or the computer processor 26. The image 600 further includes the plurality of fields 616, “Create New Project”, “All Projects Dashboard”, “White Hall Project Dashboard”. Selecting “Create New Project” of the dashboard 616 using computer interactive device 8, allows the user to create a new project with different project contract data of FIG. 4 and new owner designer contact data of FIG. 5. Selecting “All Projects Dashboard” of the dashboard 616 using device 8, allows the user to access FIG. 14 “All Projects Dashboard” which displays all of the projects created under this particular client contractor. This allows the user to return to a project previously created. When selected “White Hall Project Dashboard” of the dashboard 616 using device 8, allows the user to return to access the “White Hall Project Dashboard”. This function allows the user to access and input pertinent project documentation under this project.

FIG. 8 shows an image 700 which is displayed on the computer display device 2 of the user computer apparatus 1 of FIG. 1A, in accordance with one or more embodiments of the present invention. The computer processor 6 and/or the computer processor 26 causes the image 700 to be displayed in response to selection of FIG. 7 field 606, 614, and first selecting the “Edit Project” drop down menu and then selecting “Specification Set Up Page” in FIG. 10 field 906, FIG. 11 field 1006, FIG. 12 field 1106, FIG. 13 field 1206, FIG. 14 field 1314 by a user using user interactive device 8 of the user computer apparatus 1 shown in FIG. 1A.

The image 700 includes text 702 for “Specification Set Up Page”. The image 700 also includes text 704 for “Input Specification Sections” The image 700 also includes field 706 for “Next” which when selected using user computer interactive device 8 to go to or display the next image FIG. 9 image field 800 “Input Main Contractor/Subcontractor Contact Information List” on the computer display 22. The image 700 also includes a plurality of fields 708, each of which when selected “Create New Project”, “All Projects Dashboard”, “White Hall Project Dashboard”. Selecting “Create New Project” of the dashboard 708 using computer interactive device 8, allows the user to create a new project with different project contract data, FIG. 4 and new owner designer contact data FIG. 5. Selecting “All Projects Dashboard” of the dashboard 708 using device 8, allows the user to access FIG. 14 “All Projects Dashboard” which displays all of the projects created under this particular client contractor. This allows the user to return to a project previously created. When selected “White Hall Project Dashboard” of the dashboard 708 using device 8, allows the user to return to access the “White Hall Project Dashboard”. This function allows the user to access and input pertinent project documentation under this project.

The image 700 also includes chart or table 710. The chart or table 710 includes text or headers “Specification Sections” and “Division ‘1’-‘48’ or Division ‘1’-‘16’ (Manually Input Specification Sections). The chart 710 shows a specification numbers from ‘1’ to ‘48’ and cells or boxes next to those numbers into which information regarding what can be entered using user computer interactive device 8 into computer memory 10 and/or computer memory 30 using computer processors 6 and/or 26. Once field 710 of FIG. 8 has been completed and all specification data has been input, the user can now assign a specification number to a log line item as shown in FIG. 15A field 1436, FIG. 15B, field 1502, FIG. 15C field 1608, 1610, 1612, and FIG. 15D field 1706.

The image 700 also includes field 712 “Next” can be selected using user computer interactive device 8 to go to or display the next image FIG. 9 image 800 “Input Main Contractor/Subcontractor Contact Information List” on the computer display 22. The image 700 also includes fields 714 “Create New Project”, “All Projects Dashboard”, “White Hall Project Dashboard”. Selecting “Create New Project” of the dashboard 714 using computer interactive device 8, allows the user to create a new project with different project contract data in FIG. 4 and new owner designer contact data in FIG. 5. Selecting “All Projects Dashboard” of the dashboard 714 using device 8, allows the user to access FIG. 14 “All Projects Dashboard” which displays all of the projects created under this particular client contractor. This allows the user to return to a project previously created. When selected “White Hall Project Dashboard” of the dashboard 714 using device 8, allows the user to return to access the “White Hall Project Dashboard”. This function allows the user to access and input pertinent project documentation under this project.

FIG. 9 shows an image 800 which is displayed on the computer display device 2 of the user computer apparatus 1 of FIG. 1A, in accordance with one or more embodiments of the present invention. The computer processor 6 and/or the computer processor 26 causes the image 800 to be displayed in response to selection of FIG. 8 field 706, 712, and first selecting the “Edit Project” drop down menu and then selecting “Input Main Contractor/Subcontractor Contact Information List” in FIG. 10 field 906, FIG. 11 field 1006, FIG. 12 field 1106, FIG. 13 field 1206, FIG. 14 field 1314 by a user using user interactive device 8 of the user computer apparatus 1 shown in FIG. 1A.

The image 800 includes text 802 for “Input Main Contractor/Subcontractor Contact Information List” text only. The image 800 also includes field 804 for “Next” when selected using user computer interactive device 8 to go to or display the next FIG. 12 image field 1100 “Main Project Dashboard” on the computer display 22. The image 800 also includes a plurality of fields 806, each of which when selected “Create New Project”, “All Projects Dashboard”, “White Hall Project Dashboard”. Selecting “Create New Project” of the dashboard 806 using computer interactive device 8, allows the user to create an entirely new project with different project contract data in FIG. 4 and new owner designer contact data in FIG. 5. Selecting “All Projects Dashboard” of the dashboard 806 using device 8, allows the user to access FIG. 14 “All Projects Dashboard” which displays all of the projects created under this particular client contractor. This allows the user to return to a project previously created. When selected “White Hall Project Dashboard” of the dashboard 806 using device 8, allows the user to return to access the “White Hall Project Dashboard”. This function allows the user to access and input pertinent project documentation for this project.

The image 800 also includes chart or table 810. The chart or table 810 includes a section or field which states “(+) Create Contractor/Subcontractor” and “(X) Delete Contractor/Subcontractor”. The field 810 “(+) Create Contractor/Subcontractor” includes one plus sign (+) which is selected by the user to create a line item in field 810 of the Main Contractor/Subcontractor Contact List. The “(X) Delete Contractor/Subcontractor” is a delete function which allows the user to highlight the line item in field 810 to be deleted. Then after the line item is highlighted, the user selects the “(X) Delete Contractor/Subcontractor” function to remove the contractor/subcontractor from the list.

The image 800 also includes a plurality of fields 806, each of which when selected includes a plurality of columns into which can be entered information for a plurality of contractors/subcontractors. The columns include a first column for “Name of Contractor/Subcontractor”, a second column for “Trade”, a third column for “Company Address”, a fourth column for “Company Contact Initials”, a fifth column for “Email”, a sixth column for “Original Contract Value”, a seventh column for “Total Negotiated Change Orders”, and an eighth column for “Revised Contract Value”.

The image 800 also includes field 812 for “Next” when selected using user computer interactive device 8 to go to or display the next image which is image 800, shown in FIG. 12 for “Input Main Contractor/Subcontractor Contact Information List” on the computer display 22 which can be selected using user computer interactive device 8 and/or stored in computer memories 10 and/or 30. The image 800 also includes a plurality of fields 814, each of which when selected “Create New Project”, “All Projects Dashboard”, “White Hall Project Dashboard”. Selecting “Create New Project” of the dashboard 806 using computer interactive device 8, allows the user to create an entirely new project with different project contract data in FIG. 4 and new owner designer contact data in FIG. 5. Selecting “All Projects Dashboard” of the dashboard 806 using device 8, allows the user to access FIG. 14 “All Projects Dashboard” which displays all of the projects created under this particular client contractor. This allows the user to return to a project previously created. When selected “White Hall Project Dashboard” of the dashboard 806 using device 8, allows the user to return to access the “White Hall Project Dashboard”. This function allows the user to access and input pertinent project documentation for this project.

FIG. 10 shows an image 900 which is displayed on the computer display device 2 of the user computer apparatus 1 of FIG. 1A, in accordance with one or more embodiments of the present invention. The computer processor 6 and/or the computer processor 26 causes the image 900 to be displayed in response to selection of FIG. 9 field 810 by selecting the name of the contractor or subcontractor, FIG. 11 field 1006 selecting “White Hall Administrative Project File: (Drop Down) then selecting Contractor/Subcontractor/Vendor List, selecting FIG. 11 Field 1016 Contractor/Subcontractor/Vendor List, FIG. 12 field 1106 selecting “White Hall Administrative Project File: (Drop Down) then selecting Contractor/Subcontractor/Vendor List, selecting FIG. 12 field 1116 Contractor/Subcontractor/Vendor List, selecting FIG. 14 field 1314 & 1316 “Administrative Project File” (Drop Down) then selecting Contractor/Subcontractor/Vendor List, FIG. 15A field 1406 selecting “White Hall Administrative Project File” (Drop Down) then selecting Contractor/Subcontractor/Vendor List, selecting field 1416 Contractor/Subcontractor/Vendor List, by a user using user interactive device 8 of the user computer apparatus 1 shown in FIG. 1A.

The image 900 includes text 902 for “Subcontractor Project Folder”. The image 900 also includes field 904 for “All Projects Dashboard” which identifies a plurality of fields 906, each of which “Create New Project”, “All Projects Dashboard”, “White Hall Project Main Project Dashboard”, “White Hall Project Administrative File”, “White Hall Project Technical File”, “White Hall Project Field File” and “Edit Project”, when selected using user computer interactive device 8. Selecting “Create New Project” of the dashboard 906 using computer interactive device 8, allows the user to create a new project with different project contract data in FIG. 4 and new owner designer contact data in FIG. 5. Selecting “All Projects Dashboard” of the dashboard 906 using device 8, allows the user to access FIG. 14 “All Projects Dashboard” which displays all of the projects created under this particular client contractor. This allows the user to return to a project previously created. Selecting “White Hall Project Main Project Dashboard” allows the user to return to FIG. 12 image 1100, to review all project files associated with this project. Selecting “White Hall Project Administrative File” this drop down view lists all of the Administrative Files, for example listed in fields 914, 916. The user can select a particular administrative file to access from field 916 which links the user to a single administrative file, in FIG. 15A, field 1436. Selecting “White Hall Project Technical File” this drop down view lists all of the Technical Files, fields 918, and 920. The user can select a particular technical file to access from field 920 which links the user to a single technical file FIG. 15A, field 1436. Selecting “White Hall Project Field File” from this drop down view lists all of the Field Files, such as shown in fields 922, 924. The user can select a particular field file to access from field 924 which links the user to a single technical file shown in FIG. 15A field 1436. Selecting “Edit Project” this drop down view lists the text for FIG. 4, field 302, FIG. 5, field 402, FIG. 6, field 502, FIG. 7, field 602, FIG. 8, field 702 and FIG. 9, field 802. The user has the option to select from the items in the drop down to return to these figures to view and/or make changes to fields 310, 408, 412, 508, 512, 612, 710, and 810.

The image 900 also includes a logo 908 for and the name of a computer software program in accordance with an embodiment of the present invention “CONSTRUCTION PRO MANAGER” in field 910. The image 900 includes name, address, phone number and email address for a subcontractor or contractor for a building project in field 912. The image 900 includes text 914 for “Administrative File”, and plurality of fields 916 combining data relating to the main contractor and subcontractor, each of which can be selected using a user computer interactive device 8 to input new data or view data on display in a particular administrative log or file on user computer display 2 relating to this particular construction project.

The image 900 includes text 918 for “Technical File”, and plurality of fields 920 combining data relating to the main contractor and subcontractor, each of which can be selected using user computer interactive device 8 to input new data or view data on display in a particular technical log or file on user computer display 2 relating to this particular construction project.

The image 900 includes text 922 for “Field File”, and plurality of fields 924 combining data relating to the main contractor and subcontractor, each of which can be selected using user computer interactive device 8 to input new data or view data on display in a particular field log or file on user computer display 2 relating to this particular construction project.

The image 900 further includes field 926 which shows text relating to the main contractor, in this case “Area Construction Co. Inc.”, the building project for “CPM-WHITE HALL PROJECT”, and identifies a subcontractor having the name “Volt Electric”. The image 900 further includes field 928 which shows information regarding the contract value, negotiated change orders, revised contract sum, percent completed to date, and balance to finish.

The image 900 further includes a field 930 for “Project files” and a list in fields 932, 934 and 936 of project files which pertain only to this particular subcontractor. These project files can be accessed through selecting field 930 “Project Files” which will list all of the files listed in fields 932, 934 and 936, see FIG. 15A-15D images 1400, 1500, 1600, 1700. The other method project files may be selected is individually selecting the files listed in the field 932 administrative file, field 934 technical file and field 936 field, as shown in FIG. 15A, field 1436. Once selected the user will view only this subcontractor's files which remains separate from the main contractor's documentation and other subcontractors listed in the project.

FIG. 11 shows an image 1000 which is displayed on the computer display device 2 of the user computer apparatus 1 of FIG. 1A, in accordance with one or more embodiments of the present invention. The computer processor 6 and for the computer processor 26 causes the image 1000 to be displayed in response to selection of FIG. 9 field 810 by selecting the name of the main contractor, FIG. 10 field 906 selecting “White Hall Administrative Project File: (Drop Down) then selecting Contractor/Subcontractor/Vendor List, selecting FIG. 11, field 916 Contractor/Subcontractor/Vendor List, FIG. 12 field 1106 selecting “White Hall Administrative Project File: (Drop Down) then selecting Contractor/Subcontractor/Vendor List, selecting FIG. 12, field 1116 Contractor/Subcontractor/Vendor List, selecting fields 1314 and 1316 “Administrative Project File” (Drop Down) shown in FIG. 14, then selecting Contractor/Subcontractor/Vendor List, FIG. 15A field 1406 selecting “White Hall Administrative Project File” (Drop Down) then selecting Contractor/Subcontractor/Vendor List, selecting field 1416 Contractor/Subcontractor/Vendor List by a user using user interactive device 8 of the user computer apparatus 1 shown in FIG. 1A.

The image 1000 includes text 1002 for “Main Contractor Project Folder—White Hall Project”. The image 1000 also includes plurality of fields 1006, each of which “Create New Project”, “All Projects Dashboard”, “White Hall Project Main Project Dashboard”, “White Hall Project Administrative File”, “White Hall Project Technical File”, “White Hall Project Field File” and “Edit Project”, when selected using user computer interactive device 8. Selecting “Create New Project” of the dashboard 1006 using computer interactive device 8, allows the user to create a new project with different project contract data in FIG. 4 and new owner designer contact data in FIG. 5. Selecting “All Projects Dashboard” of the dashboard 1006 using device 8, allows the user to access FIG. 14 “All Projects Dashboard” which displays all of the projects created under this particular client contractor. This allows the user to return to a project previously created. Selecting “White Hall Project Main Project Dashboard” allows the user to return to FIG. 12 image 1100, to review all project files associated with this project. Selecting “White Hall Project Administrative File” this drop down view lists all of the Administrative Files, fields 1014, and 1016. The user can select a particular administrative file to access from field 1016 which links the user to a single administrative file, such as shown in FIG. 15A, field 1406. Selecting “White Hall Project Technical File” this drop down view lists all of the Technical Files, shown in fields 1018, and 1020. The user can select a particular technical file to access from field 1020 which links the user to a single technical file shown in FIG. 15A, field 1406. Selecting “White Hall Project Field File” this drop down view lists all of the field files, field 1022, and 1024. The user can select a particular field file to access from field 1024 which links the user to a single technical file FIG. 15A field 1406. Selecting “Edit Project” this drop down view lists the text for FIG. 4 field 302, FIG. 5 field 402, FIG. 6 field 502, FIG. 7 field 602, FIG. 8 field 702 and FIG. 9 field 802. The user has the option to select from the items in the drop down to return to these figures to view and/or make changes to fields 310, 408, 412, 508, 512, 612, 710, 810.

The image 1000 also includes a logo 1008 for and the name of a computer software program in accordance with an embodiment of the present invention “CONSTRUCTION PRO MANAGER” in field 1010. The image 1000 includes name, address, phone number and email address for a main contractor for a building project in field 1012. The image 1000 includes text 1014 for “Administrative File”, and plurality of fields 1016 combining data relating to the main contractor and subcontractor, each of which can be selected using user computer interactive device 8 to input new data or view data on display in a particular administrative log or file on user computer display 2 relating to this particular construction project.

The image 1000 includes text 1018 for “Technical File”, and plurality of fields 1020, combining data relating to the main contractor and subcontractor, each of which can be selected using user computer interactive device 8 to input new data or view data on display in a particular technical log or file on user computer display 2 relating to this particular construction project.

The image 1000 includes text 1022 for “Field File”, and plurality of fields 1024 combining data relating to the main contractor and subcontractor, each of which can be selected using user computer interactive device 8 to input new data or view data on display in a particular field log or file on user computer display 2 relating to this particular construction project.

The image 1000 further includes field 1026 which shows text relating to the main contractor, in this case “Area Construction Co. Inc.”, the building project for “CPM-WHITE HALL PROJECT”, and identifies a subcontractor having the name “Volt Electric”. The image 1000 further includes field 1028 which shows information regarding the contract value, negotiated change orders, revised contract sum, percent completed to date, and balance to finish. The field 1028 further includes the start date of the building project, anticipated completion date of the building project, and the names, addresses, contacts, phone numbers and email addresses of the main contractor, the architect, the engineer, and the owner relating to the building project.

The image 1000 further includes a field 1030 for “Project files” and a list 1032 of administrative files, a list 1034 of technical files, and a list 1036 of field files which pertain only to this particular main contractor. These project files can be accessed through selecting any of the files listed in the field 1032 administrative file, field 1034 technical file and field 1036 field file, FIGS. 15A-15D images 1400, 1500, 1600, and 1700, respectively. The other method project files may be selected by individually selecting the files listed in the field 932 administrative file, field 934 technical file and field 936 field file, see FIG. 15A, field 1436. Once selected the user will view only this subcontractor's documentation which remains separate from the main contractor's documentation and other subcontractors listed in the project.

FIG. 12 shows an image 1100 which is displayed on the computer display device 2 of the user computer apparatus 1 of FIG. 1A, in accordance with one or more embodiments of the present invention. The computer processor 6 and for the computer processor 26 causes the image 1100 to be displayed in response to selection of FIG. 4 field 306 selecting “All Projects Dashboard”, FIG. 5 field 404 selecting “All Projects Dashboard”, FIG. 6 Field 504 selecting “All Projects Dashboard”, FIG. 7 Field 608, 616, FIG. 8 fields 708, 714 selecting “All Projects Dashboard”, FIG. 9 field 806 selecting “All Projects Dashboard”, FIG. 10 field 906 selecting “All Projects Dashboard”, FIG. 11 field 1006 selecting “All Projects Dashboard”, FIG. 14 field 1314 selecting “White Hall Project Dashboard, by a user using user interactive device 8 of the user computer apparatus 1 shown in FIG. 1A.

The image 1100 includes text 1102 for “Main Project Dashboard—White Hall Project”. The image 1100 also includes plurality of fields 1106, each of which “Create New Project”, “All Projects Dashboard”, “White Hall Project Administrative File”, “White Hall Project Technical File”, “White Hall Project Field File” and “Edit Project”, when selected using computer interactive device 8, allows the user to create a new project with different project contract data, in FIG. 4 and new owner designer contact data in FIG. 5. Selecting “All Projects Dashboard” of the dashboard 1106 using device 8, allows the user to access FIG. 14 “All Projects Dashboard” which displays all of the projects created under this particular client contractor. This allows the user to return to a project previously created. Selecting “White Hall Project Administrative File” this drop down view lists all of the Administrative Files, field 1114, 1116. The user can select a particular administrative file to access from field 1116 which links the user to a single administrative file, FIG. 15A field 1406. Selecting “White Hall Project Technical File” this drop down view lists all of the Technical Files, field 1118, 1120. The user can select a particular technical file to access from field 920 which links the user to a single technical file FIG. 15A field 1406. Selecting “White Hall Project Field File” this drop down view lists all of the Field Files, field 1122, 1124. The user can select a particular field file to access from field 1124 which links the user to a single technical file FIG. 15A, field 1406. Selecting “Edit Project” this drop down view lists the text for FIG. 4, field 302, FIG. 5 field 402, FIG. 6 field 502, FIG. 7, field 602, FIG. 8, field 702 and FIG. 9. field 802. The user has the option to select from the items in the drop down to return to these figures to view and/or make changes to fields 310, 408, 412, 508, 512, 612, 710, and 810.

The image 1100 also includes a logo 1108 for and 1110 the name of a computer software program in accordance with an embodiment of the present invention “CONSTRUCTION PRO MANAGER” in field 1110. The image 1100 includes name, address, phone number and email address for a main contractor for a building project in field 1112. The image 1000 includes text 1114 for “Administrative File”, and plurality of fields 1116 combining data relating to the main contractor and subcontractor, each of which can be selected using user computer interactive device 8 to input new data or view data on display in an administrative log or file on user computer display 2 in a particular construction project.

The image 1100 includes text 1118 for “Technical File”, and plurality of fields 1120 combining data relating to the main contractor and subcontractor, each of which can be selected using user computer interactive device 8 to input new data or view data on display in a particular technical log or file on user computer display 2 relating to this particular construction project.

The image 1100 includes text 1122 for “Field File”, and plurality of fields 1124 combining data relating to the main contractor and subcontractor, each of which can be selected using user computer interactive device 8 to input new data or view data on display in a particular field log or file on user computer display 2 relating to this particular construction project.

The image 1100 further includes field 1126 which shows text relating to the main contractor, in this case “Area Construction Co. Inc., the building project for “CPM-WHITE HALL PROJECT”, and identifies a subcontractor having the name “Volt Electric”. The image 1100 further includes field 1128 which shows information regarding the contract value, negotiated change orders, revised contract sum, percent completed to date, and balance to finish. The field 1128 further includes the start date of the building project, anticipated completion date of the building project, and the names, addresses, contacts, phone numbers and email addresses of the main contractor, the architect, the engineer, and the owner relating to the building project.

The image 1100 further includes a field 1130 for “Project files” which pertain only to this particular subcontractor. These project files can be accessed through selecting field 1130 “Project Files” which will list all of the files listed in fields 1132 administrative file, field 1134 technical files and field 1136 field files, as shown in FIGS. 15A-15D images 1400, 1500, 1600, and 1700. The other method by which project files may be selected is by individually selecting the files listed in the field 1132 administrative file, field 1134 technical file and field 1136 field file, for example see FIG. 15A field 1436. Once selected the user will view only this subcontractor's documentation which remains separate from the main contractors documentation and other subcontractors listed in the project.

FIG. 13 shows an image 1200 which is displayed on the computer display device 2 of the user computer apparatus 1 of FIG. 1A, in accordance with one or more embodiments of the present invention. The computer processor 6 and for the computer processor 26 causes the image 1200 to be displayed in response to selection of “Edit Project” in FIG. 10, field 906, FIG. 11 field 1006, FIG. 12 field 1106, FIG. 14 fields 1314, and 1316, FIG. 15A field 1406, by a user using user interactive device 8 of the user computer apparatus 1 shown in FIG. 1A.

The image 1200 includes text 1202 for “Edit Project”. The image 1200 also includes plurality of fields 1206, each of which “Create New Project”, “All Projects Dashboard”, “White Hall Project Main Project Dashboard”, “White Hall Project Administrative File”, “White Hall Project Technical File”, “White Hall Project Field File” and “Edit Project”, when selected using user computer interactive device 8. Selecting “Create New Project” of the dashboard 1206 using computer interactive device 8, allows the user to create a new project with different project contract data in FIG. 4 and new owner designer contact data in FIG. 5. Selecting “All Projects Dashboard” of the dashboard 1206 using device 8, allows the user to access FIG. 14 “All Projects Dashboard” which displays all of the projects created under this particular contractor client. This allows the user to return to a project previously created. Selecting “White Hall Project Main Project Dashboard” allows the user to return to FIG. 12, image 1100, to review all project files associated with this project. Selecting “White Hall Project Administrative File” from a drop down view lists all of the Administrative Files, shown in field 1214, 1216. The user can select a particular administrative file to access from field 1216 which links the user to a single administrative file, FIG. 15B image 1500. Selecting “White Hall Project Technical File” from this drop down view lists all of the Technical Files, fields 1218, and 1220. The user can select a particular technical file to access from field 1220 which links the user to a single technical file FIG. 15B image 1500. Selecting “White Hall Project Field File” this drop down view lists all of the Field Files, fields 1222, and 1224. The user can select a particular field file to access from field 1224 which links the user to a single technical file in FIG. 15B, image 1500. Selecting “Edit Project” from this drop down view lists the text for FIG. 4 field 302, FIG. 5 field 402, FIG. 6 field 502, FIG. 7, field 602, FIG. 8, field 702 and FIG. 9, field 802. The user has the option to select from the items in the drop down to return to these figures to view and/or make changes to fields 310, 408, 412, 508, 512, 612, 710, and 810.

The image 1200 also includes a logo 1208 for and the name of a computer software program in accordance with an embodiment of the present invention “CONSTRUCTION PRO MANAGER” in field 1210. The image 1200 includes name, address, phone number and email address for a main contractor for a building project in field 1212. The image 1200 includes text 1214 for “Administrative File”, and plurality of fields 1216 combining data relating to the main contractor and subcontractor, each of which can be selected using user computer interactive device 8 to input new data or view data on display in a particular administrative log or file on user computer display 2 relating to this particular construction project.

The image 1200 includes text 1218 for “Technical File”, and plurality of fields 1220, combining data relating to the main contractor and subcontractor, each of which can be selected using user computer interactive device 8 to display an technical log or file on user computer display 2 relating to a construction project.

The image 1200 includes text 1222 for “Field File”, and plurality of fields 1224, each of which can be selected using user computer interactive device 8 to input new data or view data on display in a particular field log or file on user computer display 2 relating to this particular construction project.

FIG. 14 shows an image 1300 which is displayed on the computer display device 2 of the user computer apparatus 1 of FIG. 1A, in accordance with one or more embodiments of the present invention. The computer processor 6 and/or the computer processor 26 causes the image 1300 to be displayed in response to selection of “All Projects Dashboard” in FIG. 4, field 306, FIG. 5 field 404, FIG. 6 field 504, FIG. 7 fields 608, and 616, FIG. 8 fields 708, and 714, FIG. 9 field 806, 814, FIG. 10, field 906, FIG. 11 field 1006, FIG. 12 field 1106, FIG. 13 field 1206, FIG. 15A field 1406 by a user using user interactive device 8 of the user computer apparatus 1 shown in FIG. 1A.

The image 1300 includes text 1302 for “All Projects Dashboard”. The image 1300 also includes field 1304 for “Create New Project” when selected allows the user to create a new project with different project contract data in FIG. 4 field 302 and new owner designer contact data in FIG. 5 field 408, and 412 using user computer interactive device 8. The image 1300 also includes field 1306 for “Drop Down All Projects List” which when selected allows the user to access FIG. 14 “All Projects Dashboard” which displays all of the projects created under this particular client contractor. This allows the user to return to a project previously created using user computer interactive device 8.

The image 1300 also includes a logo 1308 for and the name of a computer software program in accordance with an embodiment of the present invention “CONSTRUCTION PRO MANAGER” in field 1310. The image 1300 includes name, address, phone number and email address for a main contractor for a building project in field 1312.

The image 1300 further includes fields 1314 for a first building or construction project “Project #1 CPM-WHITE HALL PROJECT”. Fields 1314 when selected links the user to FIG. 12 image 1100 “Main Project Dashboard” for the White Hall Project. This allows the user to view data or input data related to this project only.

The image 1300 further includes fields 1316 for a second building or construction project “Project #2 CPM-Perry New Addition”. Fields 1316 when selected links the user to FIG. 12 image 1100 “Main Project Dashboard” for the White Hall Project. This allows the user to view data or input data related to this project only.

FIGS. 15A-15D show images 1400-1700 which are displayed on the computer display device 2 of the user computer apparatus 1 of FIG. 1A, in accordance with one or more embodiments of the present invention. The computer processor 6 and for the computer processor 26 causes the images 1400-1700 to be displayed in response to selection of FIG. 10, field 930, FIG. 11 field 1030, and FIG. 12, field 1130, by a user using user interactive device 8 of the user computer apparatus 1 shown in FIG. 1A. FIGS. 15A, 15B, 15C, and 15D may be displayed together, in order so that the images 1400, 1500, 1600, and 1700 can be scrolled on the computer display device 2.

The image 1400 includes text 1402 for “Subcontractor Project Folder”. The image 1400 also includes field 1403 for “Save & Update”, which can be selected using user computer interactive device 8 to save all new data recently input into a project file. New data input into a project file will be saved to FIG. 12 Main Project Dashboard field 1030, and FIG. 10 Subcontractor Project Folder, field 930. The image 1400 also includes field 1404 for “Print”, which can be selected using user computer interactive device 8 to print individual field 1436 or fields 1436 through the images shown in FIGS. 15B-15D.

The image 1400 also includes fields 1406 can be selected each of which “Create New Project”, “All Projects Dashboard”, “White Hall Project Main Project Dashboard”, “White Hall Project Administrative File”, “White Hall Project Technical File”, “White Hall Project Field File” and “Edit Project”, when selected using user computer interactive device 8. Selecting “Create New Project” of the dashboard 1406 using computer interactive device 8, allows the user to create a new project with different project contract data in FIG. 4 field 310 and new owner designer contact data in FIG. 5 fields 408, and 412. Selecting “All Projects Dashboard” of the dashboard 1406 using device 8, allows the user to access FIG. 14 “All Projects Dashboard” which displays all of the projects created under this particular client contractor. This allows the user to return to a project previously created. Selecting “White Hall Project Main Project Dashboard” allows the user to return to FIG. 12 image 1100, to review all project files associated with this project. Selecting “White Hall Project Administrative File” this drop down view lists all of the Administrative Files, fields 1414, and 1416. The user can select a particular administrative file to access from field 1416 which links the user to a single administrative file, FIG. 15A field 1436. Selecting “White Hall Project Technical File” and this drop down view lists all of the Technical Files, in fields 1418, 1420. The user can select a particular technical file to access from field 1420 which links the user to a single technical file FIG. 15A field 1436. Selecting “White Hall Project Field File” and this causes a drop down view list of all of the Field Files, fields 1422, and 1424. The user can select a particular field file to access from field 1424 which links the user to a single technical file FIG. 15A field 1436. Selecting “Edit Project” and then a drop down menu view lists the text for FIG. 4 field 302, FIG. 5 field 402, FIG. 6 field 502, FIG. 7 field 602, FIG. 8 field 702 and FIG. 9 field 802. The user has the option to select from the items in the drop down menu to return to the image of these figures to view and/or make changes to fields 310, 408, 412, 508, 512, 612, 710, and 810.

The image 1400 also includes a logo 1408 for and the name of a computer software program in accordance with an embodiment of the present invention “CONSTRUCTION PRO MANAGER” in field 1410. The image 1400 includes name, address, phone number and email address for a main contractor for a building project in field 1412.

The image 1400 includes text 1414 for “Administrative File”, and plurality of fields 1416, combining data relating to the main contractor and subcontractor, each of which can be selected using user computer interactive device 8 to input new data or view data on display in a particular administrative log or file on user computer display 2 relating to this particular construction project.

The image 1400 includes text 1418 for “Technical File”, and plurality of fields 1420, combining data relating to the main contractor and subcontractor, each of which can be selected using user computer interactive device 8 to input new data or view data on display in a particular technical log or file on user computer display 2 relating to this particular construction project.

The image 1400 includes text 1422 for “Field File”, and plurality of fields 1424 combining data relating to the main contractor and subcontractor, each of which can be selected using user computer interactive device 8 to input new data or view data on display in a particular field log or file on user computer display 2 relating to this particular construction project.

The image 1400 further includes field 1426 which shows text relating to the main contractor, in this case “Area Construction Co. Inc., the building project for “CPM-WHITE HALL PROJECT”, and identifies a subcontractor having the name “Volt Electric”. The image 1400 further includes field 1428 which shows information regarding the original contract value, original contract sum, negotiated change orders, revised contract value revised contract sum, percent completed to date, and balance to finish for a building construction project.

The image 1400 further includes field 1430 for “Create Submittal Entry” which when selected. with user computer interactive device 8 by selecting the plus “+” Create Submittal Entry field 1430. This creates a new submittal log entry in field 1436 allowing the user to input data in columns 1 through 14. By selecting the “X” Delete Submittal Entry in field 1431, this allows the user to delete a submittal entry through highlighting the submittal entry to be deleted and then selecting the “X” Delete Submittal Entry field 1431. The image 1400 further includes text 1432 which when selected by a user using user computer interactive 8 links the use to the FIG. 12 “main project dashboard” field 1134 submittal log file. Field 1432 returns the user to the main project dashboard so to view the overall submittal log data combining all contractors for this building project.

The image 1400 further includes a row of text 1434 which indicates a specification, a contract number, and a contractor for a building project. The image 1400 further includes a table 1436 having a plurality of columns and rows. The first column of the table 1436 indicates a number of an item representing the submittal entry number which is part of the submittal log as part of this building project. The second column of the table 1436 indicates a description which represents the description of that particular submittal entry number which is part of this building project. The third column of the table 1436 indicates a section of the specification. The fourth column of the table 1436 indicates a contractor/subcontractor/vendor for the part of the building project. The fifth column of the table 1438 indicates submission entry number which can be entered using user computer interactive device 8 into the user computer 1. This fifth column represents the number of submittal entries submitted to an architect, engineer or client “For Approval”. The sixth column of the table 1436 indicates data received from the contractor/subcontractor/vendor representing construction submittals related product data, shop drawings and other documentation for this building project. The seventh column of the table 1436 indicates a number of copies sent to the architect, engineer or client as part of the submittal requirements for this building project specification. The eighth column of the table 1436 indicates a date the submittals for this building project specification as part of the project was sent to the architect, engineer or client. The ninth column of the table 1436 indicates the number of submittal copies returned from the architect, engineer or client of the submittal under this entry only. The tenth column of the table 1436 indicates the date the particular part of the submittal was received back from the architect, engineer or the client. The eleventh column indicates the number of copies received back from the architect, engineer or the client. The twelfth column indicates if the part of this submittal entry for this project has been approved, and if so an “X” is shown in the particular cell of the table 1436. The thirteenth column indicates if the part of this submittal entry for this project has been “Approved As Noted”, and if so an “X” is shown in the particular cell of the table 1436. The fourteenth column of the table 1436 indicates if this submittal entry for this project needs to be revised and resubmitted to the architect, engineer or client, and if so an “X” is shown in the particular cell of the table 1436 for this particular part of the project.

The image 1500 in FIG. 15B may be a continuation of and added to the image 1400 of FIG. 15B. The image 1500 includes table and text 1502 relating to “Create RFI”. The table 1502 includes text “(+) Create RFI” which can be selected using user interactive device 8 by selecting the plus “(+) Create RFI” in image 1502. This creates a new RFI (Request for Information) log entry in the first column allowing the user to input and manage data in the first through eighth columns By selecting the “(X) Delete RFI” in image 1502, this allows the user to delete a previously created RFI log item entry highlighting the RFI entry to be deleted and then selecting the “X” Delete RFI in image 1502.

The table 1502 includes text “RFI Log (Click on RFI Log and brings you back to RFI Page)” which can be selected using user interactive device 8 linking the user to FIG. 12 “main project dashboard” field 1134 submittal log file. The “RFI Log (Click on RFI Log and brings you back to RFI Page)” returns the user to the main project dashboard so to view the overall RFI log data combining all contractors for this building project.

The table 1502 includes headings and a row. The table 1502 includes first column which indicates an item number. The table 1502 includes a second column which states “Subcontractor (Drop Down with List of subcontractors for this project linked to sub/vendor individual page)” which can be selected on the user computer display 2 to present the list of contractors created in FIG. 9 image 810. Once the drop down menu appears with the list of contractors, the user then selects the name of the contractor as it applies to the RFI entry. The table 1502 includes a third column which states “Trade Division” and shows a number for a trade division. The table 1502 includes fourth column which includes a description of a project or part of a project, which in this case is “New Bathroom”. The fifth column of the table 1502 indicates “Date Created” which is the date the assignment for the “New Bathroom” RFI was created by the user or client contractor for this program. The sixth column of the table 1502 indicates a “Date Received from Subcontractor/Vendor” for when an RFI is received from a subcontractor or vendor. The seventh column of the table 152 indicates a “Date Sent to architect/Owner/Engineer”, which is a date the RFI assignment was sent to the architect, owner, and/or engineer. The eighth column of the table 152 indicates a “Number of days unanswered”, which in this case is “10”.

The image 1500 includes table and text 1504 relating to “Create Change Order Entry”. The table 1504 includes text “(+) Create Change Order Entry” which can be selected using user interactive device 8 by selecting the plus “(+) Create Change Order Entry” in image 1504. This creates a new change order entry in column 1 allowing the user to input data in the first through twelfth columns 1. By selecting the “(X) Delete Change Order Entry” in image 1504, this allows the user to delete a previously created change order entry through highlighting the change order entry to be deleted and then selecting the “X” Delete Change Order Entry in image 1504. The table 1504 includes text “Change Order Log” which can be selected using user interactive device 8 linking the user to FIG. 12 “main project dashboard” field 1134 submittal log file. Selecting “Change Order Log” returns the user to the main project dashboard so to view the overall change order log entries and data combining all contractors for this building project.

The table 1504 includes headings and a row. The table 1504 includes first column which indicates a main contractor (Arena Construction, in this case) change order number. The table 1504 includes a second column which indicates a subcontractor (Volt Electric, in this case) change order number. The table 1504 includes a third column which indicates an owner change order number. The table 1504 includes a fourth column which indicates a change order description. A fifth column is provided in table 1504 for an identification of a bulletin or drawings of the change. The table 1504 also includes a sixth column which indicates the date of the change proposal. A seventh column is provided in table 1504 for the name of the subcontractor and/or contractor which can be selected on the user computer display 2 to present the list of contractors created in FIG. 9 image 810. Once the drop down menu appears with the list of contractors, the user then selects the name of the contractor as it applies to the change order entry. This change order entry will be linked and saved to FIG. 10 subcontractor project folder, administrative file field 916 change order log, and linked and saved to the main project dashboard administrative file field 1116 change order log.

The table 1504 also includes an eighth column which specifies a subcontractor monetary cost w/OH&P, which is the subcontractors direct monetary cost for this change order including overhead and profit; and this is a dollar figure. The table 1504 includes a ninth column which specifies the monetary cost to the main contractor (in this case “Arena”) as it pertains to this change order entry. The table 1504 includes a tenth column which specifies overhead and profit as 15% of the cost of the ninth column. The tenth column represents the dollar figure for 15% of column nine in display for the user to view how much overhead and profit is allowable under this change order entry. The table 1504 includes an eleventh column which specifies the total price submitted including column 8, 9, 10. This is a price submitted by the main contractor for this project which includes the subcontractor's cost and main contractors cost when applicable. The table 1504 also includes a twelfth column which indicates whether the price was negotiated. In this case “N” indicates that the price was not negotiated.

The image 1500 includes table and text 1506 relating to “Create Backcharge Log Entry”. The table 1506 includes text “(+) Create Backcharge Log Entry” which can be selected using user interactive device 8 by selecting the plus “(+) Create Backcharge Log Entry” in image 1506. This creates a new Backcharge Log Entry in column 1 allowing the user to input data in the second through seventh columns to document backcharges related to a cost impact. This allows the user to document the total back charges related to a specific contractor or subcontractor linked from FIG. 9, field 810. The table 1506 includes text “BackCharge Log” which can be selected using user interactive device 8 links the user to FIG. 12 “main project dashboard” field 1132 back charge log file. Selecting “Back Charge Log” returns the user to the main project dashboard so to view the overall back charge log entries and data combining all contractors for this building project.

The table 1506 includes a field relating to “(X) Delete Backcharge Log Entry”. By selecting the “(X) Delete Backcharge Log Entry” in image 1506, this allows the user to delete a previously created backcharge log entry through highlighting the backcharge entry to be deleted, then selecting the “X” Delete Backcharge Log Entry in image 1506 which does what when selected with user interactive device 8.

The table 1506 includes a first column indicating “Backcharge #”, a second column indicating “Description of Backcharge”, a third column indicating “Breakdown”, a fourth column indicating “Dollar Value Against”, and a fifth column indicating “Remarks”. A backcharge is a charge against a contract in the form of a monetary credit against a particular work item for the cost of having others perform portions of their contract. There is a row in table 1506 for a back charge item number and a row for a total of back charges.

The image 1500 includes table and text 1508 relating to “(+) Create Insurance Log” and (X) Delete Insurance Log. The table 1508 includes text “Insurance Log” which can be selected using user interactive device 8 by selecting the plus “(+) Create Insurance Log” in image 1508. This creates a new insurance log entry in a first column allowing the user to input data in the first through ninth columns. By selecting the “(X) Delete Insurance Log” in image 1508, this allows the user to delete a previously created insurance log entry through highlighting the insurance log entry to be deleted and then selecting the “X” Delete Insurance Log in image 1508. The table 1508 includes text “Insurance Log” which can be selected using user interactive device 8 linking the user to FIG. 12 “main project dashboard” field 1132 Insurance/Bond log file. Selecting “Insurance Log” returns the user to the main project dashboard so to view the overall Insurance Log entries and data combining all contractors for this building project.

The table 1508 includes a first column indicating “Insurance Log #”, a second column indicating “Contractor/Subcontractor”, a third column indicating “Insurance Type”, a fourth column indicating “Name of Carrier”, a fifth column indicating “Policy Number”, a sixth column indicating “Issue Date”, a seventh column indicating “Expiration Date”, an eighth column indicating “Policy Attachments”, a ninth column indicating “Notes”.

The image 1600 in FIG. 15C may be a continuation of and added to the image 1400 of FIG. 15A, and the image 1500 of FIG. 15B. The image 1600 includes table and text 1602 including text “(+) Create Photo Log” and “(X) Delete Photo Log” which can be selected using user interactive device 8 by selecting the plus “(+) Create Photo Log” in image 1602. This creates a new change order entry in column 1 allowing the user to input data in first through ninth columns. By selecting the “(X) Delete Photo Log” in image 1602, this allows the user to delete a previously created insurance log entry through highlighting the insurance log entry to be deleted and then selecting the “X” Delete Photo Log in image 1602. The table 1602 includes text “Photo Log” which can be selected using user interactive device 8 linking the user to FIG. 12 “main project dashboard” field 1134 Photo log file. Selecting “Photo Log” returns the user to the main project dashboard so to view the overall photo Log entries and data combining all contractors for this building project.

The table 1602 includes a first column indicating “Item #” of a photograph, a second column indicating “Photo description”, a third column indicating “Contractor/Subcontractor”, a fourth column indicating “Trade Division”, a fifth column indicating “Date Created”, a sixth column indicating “Description”, a seventh column indicating “Assign”, a eighth column indicating “Attachments”, and an ninth column indicating “Email”.

The image 1600 includes table and text 1604 including text “(+) Create Permit Log” and “(X) Delete Permit Log” which can be selected using user interactive device 8 by selecting the plus “(+) Create Permit Log” in image 1604. This creates a new permit log entry in column 1 allowing the user to input data in first through tenth columns. By selecting the “(X) Delete Permit Log” in image 1604, this allows the user to delete a previously created insurance log entry through highlighting the permit log entry to be deleted and then selecting the “(X)” Delete Permit Log in image 1604. The table 1604 includes text “Permit Log” which can be selected using user interactive device 8 linking the user to FIG. 12 “main project dashboard” field 1134 Permit log file. Selecting “Permit Log” returns the user to the main project dashboard so to view the overall permit Log entries and data combining all contractors for this building project.

The table 1604 includes a first column indicating “Item #” of a permit, a second column indicating “Contractor/Subcontractor/Vendor”, a third column indicating “Trade Division”, a fourth column indicating “Description”, a fifth column indicating “Location”, a sixth column indicating “Permit #”, a seventh column indicating “Policy Issue Date”, a seventh column indicating “Expiration Date”, an eighth column indicating “Policy Issue Date”, a ninth column indicating “Attachment” and a tenth column indicating “Email”.

The image 1600 includes table and text 1606 including text “(+) Create Time & Material Log” and “(X) Delete Time & Material Log” which can be selected using user interactive device 8 by selecting the plus “(+) Create Time & Material Log” in image 1606. This creates a new time & material log entry in a first column allowing the user to input data in first through tenth columns. By selecting the “(X) Delete Time & Material Log” in image 1606, this allows the user to delete a previously created time & material log entry through highlighting the time & material log entry to be deleted and then selecting the “(X)” Delete Time & Material log” in image 1606. The table 1606 includes text “T & M Log” which can be selected using user interactive device 8 linking the user to FIG. 12 “main project dashboard” field 1132 Time & Material Log file. Selecting “Time & Material Log” returns the user to the main project dashboard so to view the overall time & material log entries and data combining all contractors for this building project.

The table 1606 includes a first column indicating “T&M #” representing the chronological order for when the T&M #'s are entered into the Tim & Material Log, entry number as part of the time and material spent on part of construction project, a second column indicating “Description/Location”, a third column indicating “Trade Division”, a fourth column indicating “Requested By:”, a fifth column indicating “Labor”, a sixth column indicating “Material”, a seventh column indicating “OH&P 10%”, an eighth column indicating “Total T&M” and a ninth column indicating “Attachments”, and a tenth column indicating “Email”.

The image 1600 includes table and text 1608 including text “(+) Create Training Schedule Log” and “(X) Delete Training Schedule Log” which can be selected using user interactive device 8 by selecting the plus “(+) Create Training Schedule Log” in image 1608. This creates a Training Schedule log entry in a first column allowing the user to input data in first through eighth columns. By selecting the “(X) Delete Training Schedule Log” in image 1608, this allows the user to delete a previously created Training Schedule Log entry through highlighting the Training Schedule Log entry to be deleted and then selecting the “(X)” Delete Training Schedule Log” in image 1608. The table 1608 includes text “Training Log” which can be selected using user interactive device 8 linking the user to FIG. 12 “main project dashboard” field 1134 Training Schedule Log file. Selecting “Training Log” returns the user to the main project dashboard so to view the overall Training Schedule Log entries and data combining all contractors for this building project.

The table 1608 includes a first column indicating “Training #” representing the chronological order for when the trainings are entered into the Training Log, a second column indicating “Specification Section” for training, a third column indicating “Contractor/Vendor”, a fourth column indicating “Description/Breakdown”, a fifth column indicating “Date of Training”, a sixth column indicating “Time of Training AM/PM”, a seventh column indicating “Video Submission Date” of a training video, an eighth column indicating “Note” regarding a training session, and a ninth column indicating “Attachments”.

The image 1600 includes table and text 1610 including text “(+) Create Operation & Maintenance Log” and “(X) Delete Operation & Maintenance Log” which can be selected using user interactive device 8 by selecting the plus “(+) Create Operation & Maintenance Log” in image 1610. This creates an Operation & Maintenance log entry in a first column allowing the user to input data in the first through ninth. By selecting the “(X) Delete Operation & Maintenance Log” in image 1610, this allows the user to delete a previously created Operation & Maintenance Log entry through highlighting the O&M Log entry to be deleted and then selecting the “(X)” Delete Operation & Maintenance Log” in image 1610. The table 1610 includes text “O&M Log” which can be selected using user interactive device 8 linking the user to FIG. 12 “main project dashboard” field 1134 Operation & Maintenance Log file. Selecting “O&M Log” returns the user to the main project dashboard so to view the overall Training Schedule Log entries and data combining all contractors for this building project.

The table 1610 includes a first column indicating “O & M #” representing the chronological order for when the documentation has been input into this O&M Log, a second column indicating “Specification Section” for operation and maintenance, a third column indicating a “submittal section #”, a fourth column indicating “contractor/vendor” for the operation and maintenance, a fifth column indicating “description/breakdown of the operation & maintenance”, a sixth column indicating “date submitted” regarding an operation and maintenance submission to the architect, engineer or client, a seventh column indicating a “Date Approved” regarding the date for the final approval by the architect, engineer or client for this operation and maintenance submission, an eighth column indicating “Date Sent for Final Submission”, and a ninth column indicating “Notes” regarding remarks to be documented relating to this operation and maintenance log entry item. The image 1600 includes table and text 1612 including text “(+) Create Guarantee/Warranty Log”, “(X) Delete Guarantee/Warranty Log” and text for “Guarantee & Warranty Log” which can be selected using user interactive device 8 by selecting the plus “(+) Create Guarantee/Warranty Log” in image 1612. This creates a Guarantee/Warranty Log entry in a first column allowing the user to input data in first through ninth columns. (to (do what ??) By selecting the “(X) Delete Guarantee/Warranty Log” in image 1612, this allows the user to delete a previously created Guarantee/Warranty Log entry through highlighting the Guarantee/Warranty Log entry to be deleted and then selecting the “(X)” Delete Guarantee/Warranty Log” in image 1612. The table 1612 includes text “Guarantee & Warranty Log” which can be selected using user interactive device 8 linking the user to FIG. 12 “main project dashboard” field 1134 Guarantee/Warranty Log file. Selecting “Guarantee & Warranty Log” returns the user to the main project dashboard so to view the overall Guarantee/Warranty Log entries and data combining all contractors for this building project.

The table 1612 includes a first column indicating “G&W #” representing the chronological order for when the guarantee and warranty are entered into the guarantee and warranty log for a building project or a part of a building project, a second column indicating “Specification Section” to which the part of the project relates, a third column indicating a “Product” to which this applies, a fourth column indicating a “responsible “contractor/vendor” for the building project, a fifth column indicating the contractor/vendor that the guarantee and warranty of the building project is assigned to, a sixth column indicating a “description/breakdown of a length of guarantee/warranty”, a seventh column indicating “Notes” regarding remarks to be documented relating to this project. for the guarantee or warranty, an eighth column indicating “attachments”, a ninth column indicating “Date Submitted” regarding a date submitted for the guarantee/warranty, and a tenth column indicating a date approved for the warranty.

The image 1700 in FIG. 15D may be a continuation of and added to the image 1400 of FIG. 15A, the image 1500 of FIG. 15B, and the image 1600 of FIG. 15C. The image 1700 includes table and text 1702 including text “(+) Create Punchlist Log” and “(X) Delete Punchlist Log” which can be selected using user interactive device 8 by selecting the plus “(+) Create Punchlist Log” in image 1702. This creates a Punchlist log entry in the first column allowing the user to input data in first through ninth columns. By selecting the “(X) Delete Punchlist Log” in image 1702, this allows the user to delete a previously created Punchlist Log entry through highlighting the Punchlist # Log entry to be deleted and then selecting the “(X)” Delete Punchlist Log” in image 1702. The table 1702 includes text “Punchlist Log” which can be selected using user interactive device 8 linking the user to FIG. 12 “main project dashboard” field 1134 Punchlist Log file. Selecting “Punchlist Log” returns the user to the main project dashboard so to view the overall Punchlist Log entries and data combining all contractors for this building project. The text for “LOCATION:MAIN FLOOR” which indicates that this refers to the main floor of a building.

The table 1702 includes a first column indicating “PUNCH LIST #” representing the chronological order for when the documentation has been input into this Punchlist Log. A punch list is a list of construction related tasks within a project remaining incomplete or unfinished at the end of a project. The punchlist is normally prepared by an architect or an owners' representative. The table 1702 includes second column indicating “Description/Breakdown”, a third column indicating “location”, a fourth column indicating “Subcontractor/Vendor”, a fifth column indicating “Status”, a sixth column indicating “Date Created”, a seventh column indicating “Due Date”, an eighth column indicating “Date Completed”, a ninth column indicating “Days Overdue”.

The image 1700 includes table and text 1704 including text “(+) Create Correspondence Log” and “(X) Delete Correspondence Log” which can be selected using user interactive device 8 by selecting the plus “(+) Create Correspondence Log” in image 1704. This creates a Correspondence log entry in the first column in image 1700 allowing the user to input data in first through ninth columns 1 through 9 in image 1700. By selecting the “(X) Delete Correspondence Log” in image 1704, this allows the user to delete a previously created Correspondence Log entry through highlighting the Correspondence # entry to be deleted and then selecting the “(X)” Delete Correspondence Log” in image 1704. The table 1704 includes text “Correspondence Log” which can be selected using user interactive device 8 linking the user to FIG. 12 “main project dashboard” field 1132 Log file. Selecting “Correspondence Log” returns the user to the main project dashboard so to view the overall Correspondence Log entries and data combining all contractors for this building project.

The table 1704 includes a first column indicating an item number “Correspondence #” representing the chronological order for Correspondence entry which is entered into the Correspondence log for a building project or a part of a building project of a correspondence, a second column indicating “Description” of the correspondence, a third column indicating “Date Sent” of a correspondence, a fourth column indicating “Sent to” of the correspondence“, a fifth column indicating “Received from, a sixth column indicating “Date Received”, and a seventh column indicating “Attached Correspondence”.

The image 1700 includes table and text 1706 including text “(+) Create Dwg/Sketch/Bulletin Log” and “(X) Delete Dwg/Sketch/Bulletin Log” which can be selected using user interactive device 8 by selecting the plus “(+) Create Dwg/Sketch/Bulletin Log” in image 1706. This creates a Dwg/Sketch/Bulletin log entry in a first column in image 1700 allowing the user to input data in first through seventh columns. By selecting the “(X) Delete Dwg/Sketch/Bulletin Log” in image 1706, this allows the user to delete a previously created Dwg/Sketch/Bulletin Log entry through highlighting the Correspondence # entry to be deleted and then selecting the “(X)” Delete Dwg/Sketch/Bulletin Log” in image 1706. The table 1706 includes text “Dwg/Sketch/Bulletin Log” which can be selected using user interactive device 8 linking the user to FIG. 12 “main project dashboard” field 1134 Dwg/Sketch/Bulletin Log file. Selecting “Dwg/Sketch/Bulletin Log” returns the user to the main project dashboard so to view the overall Dwg/Sketch/Bulletin Log entries and data combining all contractors for this building project.

The table 1706 includes a first column indicating an item number “Dwgs/Sketch/Bulletin #” representing the chronological order for when the documentation has been input into this drawing/sketch or bulletin log related to a building project, a second column indicating “Specification section” that the drawing, sketch or bulletin relates to, a third column indicating “Contractor/Vendor” who the drawings/sketch or bulletin apply to, column fourth indicating a description of the drawing, sketch, or bulleting, a fifth column indicating a date received for the drawing, sketch or bulletin, a sixth column related to a date sent to a subcontractor or vendor, and a seventh column indicating a “Change Order Number” regarding the drawing, sketch, or bulletin.

The image 1700 includes table and text 1708 including text “(+) Create Transmittal Log” and “(X) Delete Transmittal Log” which can be selected using user interactive device 8 by selecting the plus “(+) Create Transmittal Log” in image 1708. This creates a Transmittal log entry in a first column allowing the user to input data in first through eighth columns. By selecting the “(X) Delete Transmittal Log” in image 1708, this allows the user to delete a previously created Transmittal Log entry through highlighting the Transmittal # entry to be deleted and then selecting the “(X)” Delete Transmittal Log” in image 1708. The table 1708 includes text “Transmittal Log” which can be selected using user interactive device 8 linking the user to FIG. 12 “main project dashboard” field 1132 Transmittal Log file. Selecting “Transmittal Log” returns the user to the main project dashboard so to view the overall Transmittal Log entries and data combining all contractors for this building project.

The table 1708 includes a first column indicating an item number “Transmittal #” of a transmittal related to a building project, a second column indicating “Trade” that the transmittal relates to, a third column indicating “Description” regarding the transmittal, a fourth column indicating a date sent of the transmittal, a fifth column indicating a reason for sending, a sixth column indicating a transmittal attachment, a seventh column indicating a list email addresses that the transmittal was sent to, and an eighth column concerning remarks about the transmittal.

The image 1700 also includes field 1710 for Save & Update” which can be selected using user interactive device 8 to save and update information from the image 1700. The image 1700 also includes field 1712 for “Print” which can be selected to print the information and/or all of the images 1400, 1500, 1600, and 1700 at the same time.

In at least one embodiment of the present invention the following administrative project files and/or specialty administrative reports are stored in computer memory 10 by the computer processor 6: (1) insurance/bond log, (2) procurement log, (3) contractor/subcontractor list log, (4) permit log, (5) change order log, (6) overall project schedule Log, (7) monthly look-ahead schedule, (8) two week look-ahead schedule, (9) back charge log, (10), time and material log, (11) purchase order log, (12) correspondence log, (13) transmittal log, (14) requisition log, (15) notice to proceed log, (16) schedule of values log, (17) request for proposal log, and (18) email log.

In at least one embodiment of the present invention the following technical project files and/or specialty technical reports are stored in computer memory 10 by the computer processor 6: (1) submittal log, (2) warranty/guarantee log, (3) photo log, (4) operation & maintenance log, (5) drawing log, (6) training schedule log, (7) request for Information log, (8) punch list log, (9) non-conformance log, and (10) scope of work log.

In at least one embodiment of the present invention the following field project files and/or specialty field reports are stored in computer memory 10 by the computer processor 6: (1) daily report log, (2) safety training log, (3) safety violation log, (4) safety orientation worker log, (5) accident report log, (6) meeting minute log, (7) keying schedule log, (8) worker—emergency contact log, (9) daily time sheet log, (10) worker sign in log, (11) wage rate log, and (12) material lead time/delivery log, 13). weather delay log.

In at least one embodiment of the present invention the following specialty project files and/or specialty reports are stored in computer memory 10 by the computer processor 6: (1) change order reports, (2) change order form, (3) request for information letter of transmittal, (4) letter of transmittal general format, (5) project schedule—print, (6) monthly look ahead—print, (7) two week look ahead—print, (8) daily report—print, (9) punch list, (10) purchase order, (11) projecting meeting minutes, (12) requisition breakdown, (13) safety violation notice, (14) worker—emergency contact form, (15) accident report form, (16) daily time sheet, and (17) scope of work breakdown.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a computer processor; and
a computer memory;
wherein the computer processor is programmed to store in the computer memory, a name of a main contractor for a construction project;
wherein the computer processor is programmed to store in the computer memory, one or more names for subcontractors for the construction project;
wherein the computer processor is programmed to store in the computer memory, a main project folder for the construction project;
wherein the computer processor is programmed to store in the computer memory, a main contractor folder for the construction project;
wherein the computer processor is programmed to store in the computer memory, one or more subcontractor folders for the construction project;
wherein the main contractor folder includes data relating to one or more responsibilities of the main contractor for the construction project;
wherein each of the one or more subcontractor folders includes data relating to one or more responsibilities of a subcontractor to whom each of the one or more subcontractor folders belongs; and
wherein the main project folder includes data which is also included in the main contractor folder and data which is also included in each of the one or more subcontractor folders.
wherein the computer processor is programmed to display a first dashboard image on a computer display, wherein the first dashboard image includes a first plurality of fields; and
wherein the computer processor is programmed to configure the first plurality of fields such that selection of a first field of the first plurality of fields causes data from the main project folder to be displayed on the computer display, selection of a second field of the first plurality of fields causes data from the main contractor folder to be displayed on the computer display, and selection of a third field of the first plurality of fields causes data from one of the one or more subcontractor folders to be displayed.

2. The apparatus of claim 1 wherein
the computer processor is programmed to display a second plurality of fields related to the main contractor folder, such that each of the second plurality of fields can be selected by a user to display a corresponding main contractor log related to a responsibility of the main contractor, such that there are a plurality of main contractor logs, one main contractor log for each of the second plurality of fields, each of the plurality of main contractor logs referring to a different responsibility for the main contractor.

3. The apparatus of claim 1 wherein
the computer processor is programmed to display one or more pluralities of fields related to each of the one or more subcontractor folders, such that each field of the one or more pluralities of fields can be selected by a user to display a subcontractor log related to a responsibility of each of the one or more subcontractors, such that there are one or more pluralities of subcontractor logs for each of the one or more subcontractor folders, wherein each subcontractor log for each plurality of subcontractor logs is different from every other subcontractor log in that plurality of subcontractor logs.

4. A method comprising the steps of:
storing in a computer memory, a name of a main contractor for a construction project;
storing in the computer memory, one or more names for subcontractors for the construction project;
storing in the computer memory, a main project folder for the construction project;
storing in the computer memory, a main contractor folder for the construction project;
storing in the computer memory, one or more subcontractor folders for the construction project;
wherein the main contractor folder includes data relating to one or more responsibilities of the main contractor for the construction project;
wherein each of the one or more subcontractor folders includes data relating to one or more responsibilities of a subcontractor to whom each of the one or more subcontractor folders belongs; and
wherein the main project folder includes data which is also included in the main contractor folder and data which is also included in each of the one or more subcontractor folders;
and further comprising displaying a first dashboard image on a computer display, wherein the first dashboard image includes a first plurality of fields; and
wherein the first plurality of fields are configured such that selection of a first field of the first plurality of fields causes data from the main project folder to be displayed on the computer display, selection of a second field of the first plurality of fields causes data from the main contractor folder to be displayed on the computer display, and selection of a third field of the first plurality of fields causes data from one of the one or more subcontractor folders to be displayed.

5. The method of claim 4 further comprising
displaying a second plurality of fields related to the main contractor folder, such that each of the second plurality of fields can be selected by a user to display a corresponding main contractor log related to a responsibility of the main contractor, such that there are a plurality of main contractor logs, one main contractor log for each of the second plurality of fields, each of the plurality of main contractor logs referring to a different responsibility for the main contractor.

6. The method of claim 4 further comprising
displaying one or more pluralities of fields related to each of the one or more subcontractor folders, such that each field of the one or more pluralities of fields can be selected by a user to display a subcontractor log related to a responsibility of each of the one or more subcontractors, such that there are one or more pluralities of subcontractor logs for each of the one or more subcontractor folders, wherein each subcontractor log for each plurality of subcontractor logs is different from every other subcontractor log in that plurality of subcontractor logs.

7. A computer readable medium comprising computer executable instructions which, when executed by a processor, perform the steps of:
storing in a computer memory, a name of a main contractor for a construction project;
storing in the computer memory, one or more names for subcontractors for the construction project;
storing in the computer memory, a main project folder for the construction project;
storing in the computer memory, a main contractor folder for the construction project;
storing in the computer memory, one or more subcontractor folders for the construction project;
wherein the main contractor folder includes data relating to one or more responsibilities of the main contractor for the construction project;
wherein each of the one or more subcontractor folders includes data relating to one or more responsibilities of a subcontractor to whom each of the one or more subcontractor folders belongs; and
wherein the main project folder includes data which is also included in the main contractor folder and data which is also included in each of the one or more subcontractor folders;
and further comprising displaying a first dashboard image on a computer display, wherein the first dashboard image includes a first plurality of fields; and
wherein the first plurality of fields are configured such that selection of a first field of the first plurality of fields causes data from the main project folder to be displayed on the computer display, selection of a second field of the first plurality of fields causes data from the main contractor folder to be displayed on the computer display, and selection of a third field of the first plurality of fields causes data from one of the one or more subcontractor folders to be displayed.

8. The computer readable medium of claim 7 which further perform the further step of:
displaying a second plurality of fields related to the main contractor folder, such that each of the second plurality of fields can be selected by a user to display a corresponding main contractor log related to a responsibility of the main contractor, such that there are a plurality of main contractor logs, one main contractor log for each of the second plurality of fields, each of the plurality of main contractor logs referring to a different responsibility for the main contractor.

9. The computer readable medium of claim 7 which further perform the step of:
displaying one or more pluralities of fields related to each of the one or more subcontractor folders, such that each field of the one or more pluralities of fields can be selected by a user to display a subcontractor log related to a responsibility of each of the one or more subcontractors, such that there are one or more pluralities of subcontractor logs for each of the one or more subcontractor folders, wherein each subcontractor log for each plurality of subcontractor logs is different from every other subcontractor log in that plurality of subcontractor logs.
